(19) United States
(12) Patent Application Publication
(10) Pub. No.: US 2015/0097719 A1
(43) Pub. Date: Apr. 9, 2015

(54) SYSTEM AND METHOD FOR ACTIVE REFERENCE POSITIONING IN AN AUGMENTED REALITY ENVIRONMENT

(71) Applicant: SULON TECHNOLOGIES INC., Markham (CA)

(72) Inventors: Dhanushan BALACHANDRESWARAN, Richmond Hill (CA); Taoi HSU, Oakville (CA); Jian ZHANG, Oakville (CA)

(21) Appl. No.: 14/506,386

(22) Filed: Oct. 3, 2014

Related U.S. Application Data
(60) Provisional application No. 61/886,423, filed on Oct. 3, 2013.

(51) Int. Cl. G06T 19/00; G01B 7/00; G01S 17/06; G01S 13/06; G01S 15/06

(52) U.S. Cl. CPC G06T 19/006; G01S 13/06; G01S 15/06; G01S 17/06; G01B 7/003; G06T 2215/16
USPC 342/147; 367/99; 356/4.01; 324/207.11

(57) ABSTRACT

A multi dynamic environment and location based active augmented reality (AR) system is described. The system uses dynamic scanning, active reference marker positioning, inertial measurement, imaging, mapping and rendering to generate an AR for a physical environment. The scanning and imaging are performed from the perspective of a user wearing a head mounted or wearable display in the physical environment.

### TECHNICAL FIELD

The following relates generally to systems and methods for augmented and virtual reality environments, and more specifically to systems and methods for location tracking in dynamic augmented and virtual reality environments.

### BACKGROUND

The range of applications for augmented reality (AR) and virtual reality (VR) visualization has increased with the advent of wearable technologies and 3-dimensional (3D) rendering techniques. AR and VR exist on a continuum of mixed reality visualization.

### SUMMARY

In embodiments, a local positioning system for determining a position of a user interacting with an augmented reality of a physical environment on a wearable display. The system comprises: at least one emitter, located at a known location in the physical environment, to emit a signal; a receiver disposed upon the user to detect each signal; and a processor to: (i) determine, from the at least one signal, the displacement of the receiver relative to the at least one emitter; and (ii) combine the displacement with the known location.

In further embodiments, a method is described for determining a position of a user interacting with an augmented reality of a physical environment on a wearable display, the method comprising: by a receiver disposed upon the user, detecting each signal from each of at least one receiver with a corresponding known location within the physical environment; in a processor, determining, from the at least one signal, the displacement of the receiver relative to the at least one emitter, and combining the displacement with the known location for at least one emitter.

These and other embodiments are contemplated and described herein in greater detail.

### BRIEF DESCRIPTION OF THE DRAWINGS

A greater understanding of the embodiments will be had with reference to the Figures, in which:

FIG. 1 illustrates an exemplary physical environment in which multiple users equipped with HMDs engage with the physical environment;

FIG. 2 is a schematic illustration of the components and processing in an embodiment of a system for AR and VR engagement with a physical environment;

FIG. 3 is an exemplary system layout for multi-user engagement with an AR and/or VR environment;

FIG. 4 illustrates systems and subsystems for multi-user engagement with an AR and/or VR environment;

FIG. 5 illustrates an embodiment of an HMD for user engagement with an AR and/or VR physical environment;

FIG. 6 illustrates another embodiment of an HMD for user engagement with an AR and/or VR physical environment;

FIG. 7 illustrates an embodiment of a scanning system for an HMD;

FIG. 8 illustrates differences between stabilised and unstabilised scanning systems for an HMD;

FIG. 9A illustrates an embodiment of a stabiliser unit for an HMD;

FIG. 9B illustrates another embodiment of a stabiliser unit for an HMD;

FIG. 10 illustrates a method for controlling a stabiliser unit on an HMD;

FIG. 11 illustrates aspects of a technique for trilaterising in a physical environment;

FIG. 12 illustrates aspects of a technique for triangulating in a physical environment;

FIG. 13 illustrates an embodiment of a magnetic locating device;

FIG. 14 illustrates a multi-space physical environment occupied by multiple users equipped with HMDs;

FIG. 15 shows an embodiment of a processor for performing tasks relating to AR and VR;

FIG. 16 shows components of an AR and VR HMD;

FIGS. 17A and 17B illustrates aspects of user interaction with an AR;

FIG. 18 shows an embodiment of a system for handling multiple input and output signals in an AR/VR system;

FIG. 19A is a schema of components in an embodiment of a peripheral device for an AR and VR system;

FIG. 19B is an embodiment of a peripheral device for an AR and/or VR system;

FIG. 20A illustrates an exemplary scenario in an AR game;

FIG. 20B illustrates another perspective of the exemplary scenario of FIG. 20A;

FIG. 21 illustrates exemplary configurations of another peripheral device for an AR and/or VR system;

FIG. 22 is a schema of components in an embodiment of the peripheral device shown in FIG. 21;

FIG. 23 is a schema of an infrared (IR) receiver and transmitter pair for an AR and/or VR system;

FIG. 24 illustrates an exemplary scenario in an AR application;

FIG. 25 shows a technique for displaying an AR based on a physical environment;

FIG. 26 illustrates an embodiment of a scanning technique using structured-light; and

FIG. 27 illustrates local positioning for multiple components in an AR system using active reference marker-based tracking.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

The present disclosure is directed to systems and methods for augmented reality (AR). However, the term “AR” as used herein may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following refers to “AR” but is understood to include all of the foregoing and other variations recognized by the skilled reader. Systems and methods are provided herein for generating and displaying AR representations of a physical environment occupied by a user.

In embodiments, a system is configured to survey and model in 2- and/or 3-dimensions a physical environment. The system is further configured to generate AR layers to augment the model of the physical environments. These layers may be dynamic, i.e., they may vary from one instance to the next. The layers may comprise characters, obstacles and other graphics suitable for, for example, “gamifying” the physical environment by overlaying the graphics layers onto the model of the physical environment.

The following is further directed to a design and system layout for a dynamic environment and location in which an augmented reality system allows users to experience an actively simulated or non-simulated indoor or outdoor augmented virtual environment based on the system adaptively and dynamically learning its surrounding physical environment and locations.

In still further aspects, the following provides dynamic mapping and AR rendering of a physical environment in which a user equipped with a head mounted display (HMD) is situated, permitting the user to interact with the AR rendered physical environment and, optionally, other users equipped with further HMDs.

In yet further aspects, the following provides an HMD for displaying AR rendered image streams of a physical environment to a user equipped with an HMD and, optionally, to other users equipped with further HMDs or other types of displays.

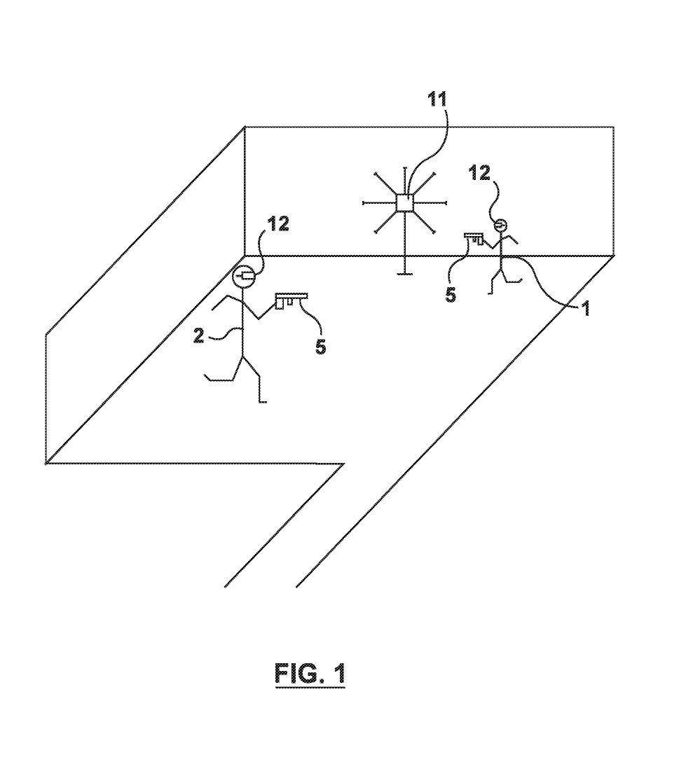

Referring now to FIG. 1, a first user 1 and a second user 2 are situated in a physical environment, shown here as a room. Each user is equipped with an HMD 12 and a peripheral 5. In an exemplary scenario, both users are engaged in game play, either independently, or in interaction with each other. In either case, each user may move about the physical environment, which the user experiences as an AR. Each user's HMD 12 dynamically, optionally in conjunction with other processing devices described herein, such as a console 11, maps and renders the physical environment as an AR, which the HMD 12 displays to the user.

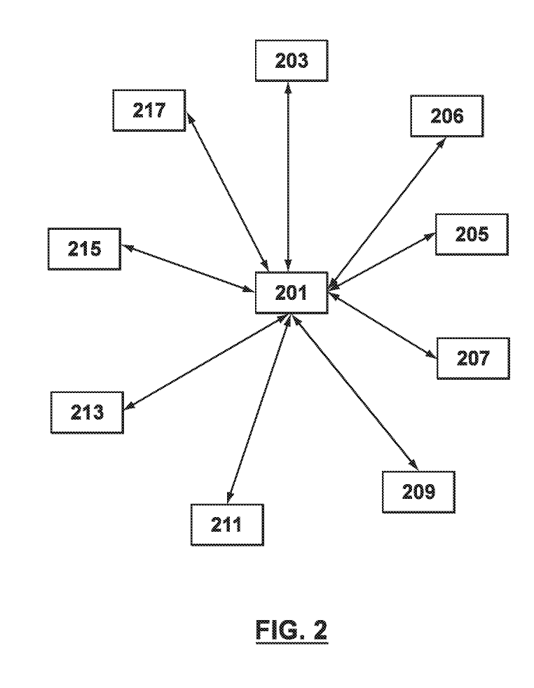

As shown in schematic form in FIG. 2, each user's HMD (which is configured to provide some or all functionality required for AR rendering of the physical environment, whether for game play, role play, training, or other types of applications where AR interaction with the physical environment is demanded) either comprises, or is configured to communicate with, a processor 201 wherein the HMD generates signals corresponding to sensory measurements of the physical environment and the processor 201 receives the signals and executes instructions relating to imaging, mapping, positioning, rendering and display. The processor 201 may communicate with: (i) at least one scanning system 203 for scanning features of the physical environment; (ii) at least one HMD positioning system 205 for determining the position of the HMD within the physical environment; (iii) at least one inertial measurement unit 206 to detect orientation, acceleration and/or speed of the HMD; (iv) at least one imaging system 207 to capture image streams of the physical environment; (v) at least one display system 209 for displaying to a user of the HMD the AR rendering of the physical environment; and (vi) at least one power management system 217 for receiving and distributing power to the components. The processor may further be configured to communicate with: peripherals 211 to enhance user engagement with the AR rendered environment; sensory feedback systems 213 for providing sensory feedback to the user; and external devices 215 for enabling other users of HMDs to engage with one another in the physical environment. These and other systems and components are described herein in greater detail. It will be appreciated that the term ‘processor’ as used herein is contemplated as being implemented as a single processor or as multiple distributed and/or disparate processors in communication with the components and/or systems requiring the processor or processors to perform tasks, as described in greater detail.

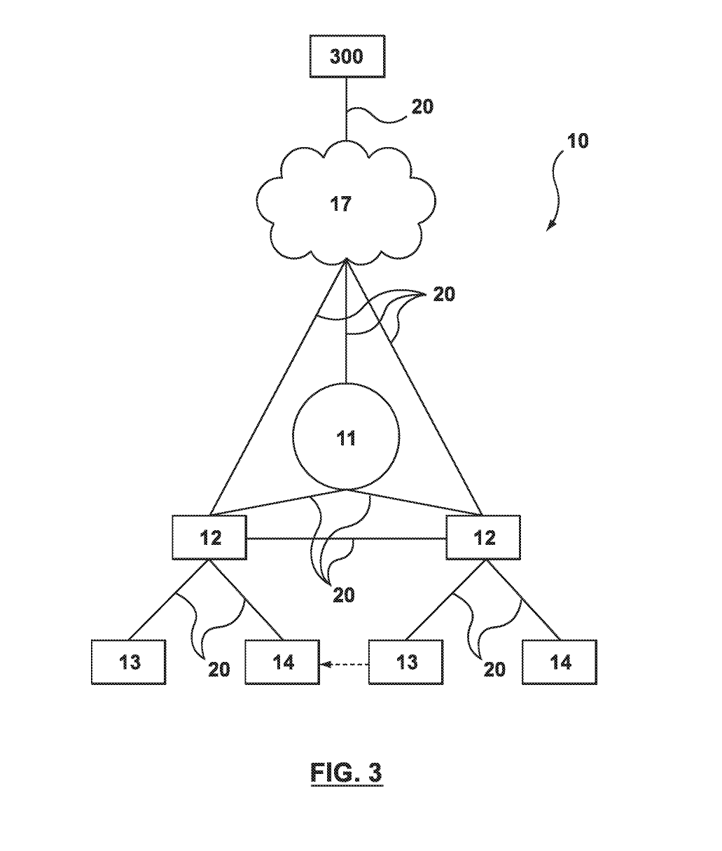

Referring now to FIG. 3, an exemplary configuration is illustrated in which two HMDs 12, each corresponding to a user, are situated in the same physical environment. The two HMDs 12 may be conceptualised as components of a single system enabling interactions between users of the HMDs 12, as well as between each user and a physical environment. The system comprises: a server 300 linked to a network 17, such as, for example, a local area network (LAN) or the Internet; and at least one HMD 12 linked to the network 17 and in network communication 20 with the server 300. As illustrated in FIG. 2, the system may further comprise a console 11 in communication 20 with the at least one HMD 12 and the server 300. Each HMD 12 may further comprise peripherals, or accessories, such as, for example an emitter 13 and a receiver 14. These and other components are described herein in greater detail.

Communication 20 between the various components of the system is effected through one or more wired or wireless connections, such as for example, Wi-Fi, 3G, LTE, cellular or other suitable connection.

As previously described, each HMD 12 generates signals corresponding to sensory measurements of the physical environment and the processor receives the signals and executes instructions relating to imaging, mapping, positioning, rendering and display. While each HMD 12 may comprise at least one embedded processor to carry out some or all processing tasks, the HMD 12 may alternatively or further delegate some or all processing tasks to the server 300 and/or the console 11. The server 300 may act a master device to the remaining devices in the system. In embodiments, the system 10 is configured for game play, in which case the server 300 may manage various game play parameters, such as, for example, global positions and statistics of various players, i.e., users, in a game. It will be appreciated that the term “player” as used herein, is illustrative of a type of “user”.

Each HMD 12 may not need to delegate any processing tasks to the server 300 if the console 11 or the processor embedded on each HMD is, or both the console and the processor embedded on each HMD together are, capable of performing the processing required for a given application. In embodiments, at least one HMD 12 may serve as a master device to the remaining devices in the system.

The console 11 is configured to communicate data to and from the server 300, as well as at least one HMD 12. The console 11 may reduce computational burdens on the server 300 or the processor embedded on the HMD 12 by locally performing computationally intensive tasks, such as, for example, processing of high level graphics and complex calculations. In particularly computationally demanding applications, for example, the network 17 connection to the server 300 may be inadequate to permit some types of remote processing.

Each HMD 12 may be understood as a subsystem to the system 10 in which each HMD 12 acts as a master to its peripherals, which are slaves. The peripherals are configured to communicate with the HMD 12 via suitable wired or wireless connections, and may comprise, for example, an emitter 13 and a receiver 14.

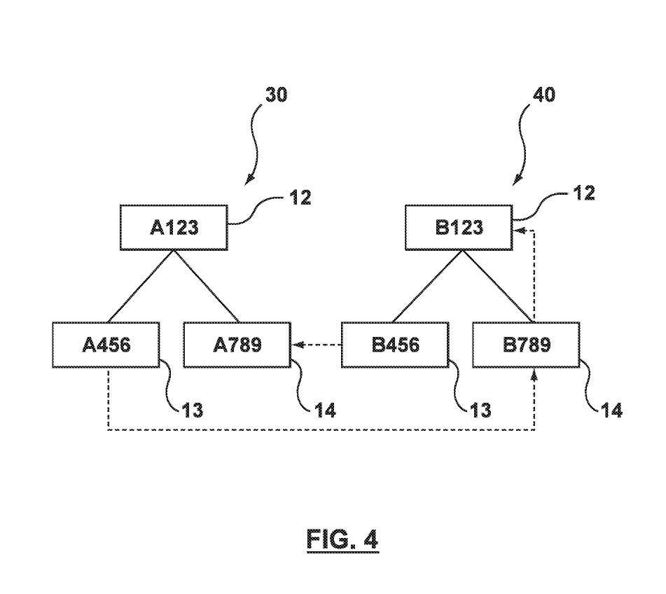

The peripherals may enhance user interaction with the physical and rendered environments and with other users. For example, the emitter 13 of a first user may emit a signal (shown in FIGS. 3 and 4 as a dashed line), such as, for example, an infrared signal, which the receiver 14 of another user is configured to detect, for example by way of an infrared sensor in the receiver 14. Such capabilities may enable some game play applications, such as, for example, a game of laser tag. For example, if a first user causes the emitter 13 to emit an infrared beam at the receiver 14 of a second user, the second user's receiver 14 registers the beam and notifies the second user's HMD 12 of the “hit”. The second user's HMD 12, in turn, communicates the hit to the central console 11, the server 300, and/or directly to the first user's HMD 12, depending on the configuration. Further, the emitters 13 and/or receivers may provide real life feedback to the user through actuators and/or sensors.

The console 11 may collect any type of data common to all HMDs in the field. For example, in a game of laser tag, the console 11 may collect and process individual and team scores. The console 11 may further resolve conflicts arising between HMDs in the field, especially conflicts involving time. For example, during a laser tag game, two players may “tag” or “hit” each other at the approximately the same time. The console 11 may exhibit sufficient timing accuracy to determine which player's hit preceded the other's by, for example, assigning a timestamp to each of the reported tags and determining which timestamp is earlier.

The console may further resolve positioning and mapping conflicts. For example, when two players occupy the same physical environment, both users occupy the same map of the physical environment. Mapping is described herein in greater detail. The console 11 therefore tracks the position of each player on the map so that any AR rendering displayed to each player on her respective HMD 12 reflects each player's respective position. When multiple users equipped with HMDs 12 are situated in the same physical environment, their respective HMDs may display analogous renderings adjusted for their respective positions and orientations within the physical environment. For example, in a game of augmented reality laser tag, if a rear player located behind a front player fires a beam past the front player, the front player sees a laser beam fired past him by the rear player, without seeing the rear player's gun.

By displaying AR renderings of the physical environment to each user, it will be appreciated that each user may experience the physical environment as a series of different augmented environments. In one exemplary scenario, by varying the display to the user on his HMD 12 with appropriate AR details, a user situated in a physical room of a building may experience the physical room first as a room in a castle and then second as an area of a forest.

As shown in FIG. 4, the system may mediate multiple users by assigning a unique serial ID to each user's HMD 12 and its peripherals. Each collection of an HMD 12 and associated peripherals may be considered subsystems of the system 10. Although two subsystems are shown, it will be appreciated that there may be more than two users each of whom is equipped with a subsystem. For example, in a game of laser tag, each of a first user's subsystem 30 and second user's subsystem 40 may comprise: an HMD 12, an emitter 13 and a receiver 14. If, for example, the receiver 14 of the second user's subsystem 30 registers a “hit” by the emitter 13 of the first user's subsystem 40, as previously described, the “hit” is identified as having been made against the receiver 14 having unique serial ID B789 of the second user's subsystem 40, and further with the user's HMD 12 having unique serial ID B123. Similarly, the “hit” is identified as having been made by the emitter 13 having unique serial ID B456 of the first user's subsystem 30 for the HMD 12 having unique serial ID A123. As each HMD 12 is a master device to the peripheral emitters 13 and receivers 14, the “hit” is communicated as shown by the stippled line, from the receiver 13 having unique serial ID B789,to the HMD 12 having unique serial ID B123 to alert the user of the second subsystem 40 that he has been tagged or “hit”. The “hit” may be communicated to the other users in the system via their respective HMDs and associated peripherals.

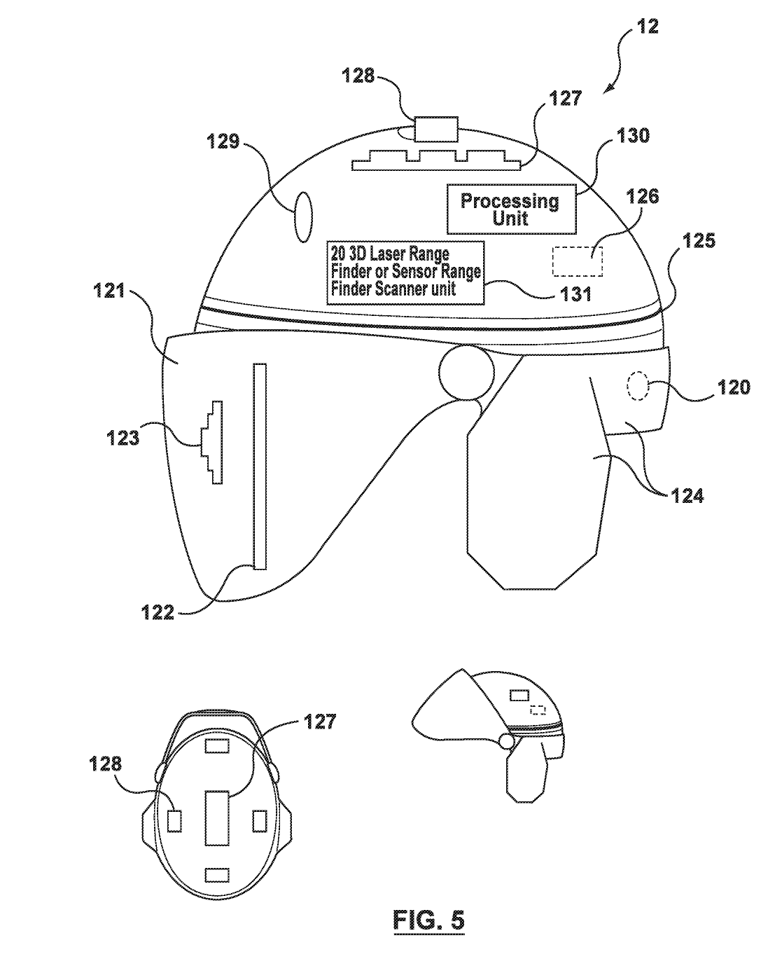

It will be appreciated that the present systems and methods, then, enable interaction with a physical environment as an AR scene of that environment. The HMD may be central to each user's experience of the physical environment as an AR environment in which the user may experience, for example, game play or training. As shown in FIG. 5, the HMD may be configured as a helmet having a visor; however, other configurations are contemplated. The HMD 12 may comprise: a display system 121 having a display 122, such as, for example, a flat panel display; a camera system 123 which may include one or more cameras; an audio system 124 with audio input and output to provide the user with audio interaction; one or more haptic feedback devices 120; a scanner/range finder 125, such as, for example a 360 degree IR and/or laser range finder (LRF)/scanner for 2D/3D mapping; wireless communication hardware 126 and antenna; an inertial measurement unit 127, such as, for example, a 3-axis accelerometer, 3-axis compass or 3-axis gyroscope; and/or a 2D/3D wireless local position system 128 provided by ultrasonic, RF, other wireless or magnetic tracking technologies or other suitable local positioning technologies. The HMD 12 may further comprise one or more receivers 129 to detect beams from other users' peripherals, as described herein in greater detail.

As previously described with respect to FIG. 2, the HMD may be configured with a processor to carry out multiple functions, including rendering, imaging, mapping, positioning, and display.

With reference to FIG. 2, the HMD comprises a scanning system 203 in communication with the processor 201. In conjunction with the processor 201, the scanning system 203 is configured to scan and map the surrounding physical environment, whether in 2D or 3D. The generated map may be stored locally in the HMD or remotely in the console or server. The map serves as the basis for AR rendering of the physical environment, allowing the user to safely and accurately navigate and interact with the physical environment.

Further, since the scanning system is mounted to a user, rather than to a fixed location within the physical environment, scanning and mapping are inside-out (i.e., scanning occurs from the perspective of the user outwards toward the physical environment, rather than from the perspective of a fixed location in the physical environment and scanning the user) enabling dynamic scanning and mapping. As a user traverses and explores a physical environment, the scanning system and the processor cooperate to learn and render an AR scene comprising the physical environment based at least on the dynamic scanning and mapping.

The HMD may scan and map regions of the physical environment even before displaying AR for those regions to the user. The scanning system may “see” into corridors, doors, rooms, and even floors. Preferably, the scanning system scans the physical environment ahead of the user so that AR renderings for that portion of the physical environment may be generated in advance of the user's arrival there, thereby mitigating any lag due to processing time. The HMD may further create a “fog of war” by limiting the user's view of the rendered physical environment to a certain distance (radius), while rendering the AR of the physical environment beyond that distance.

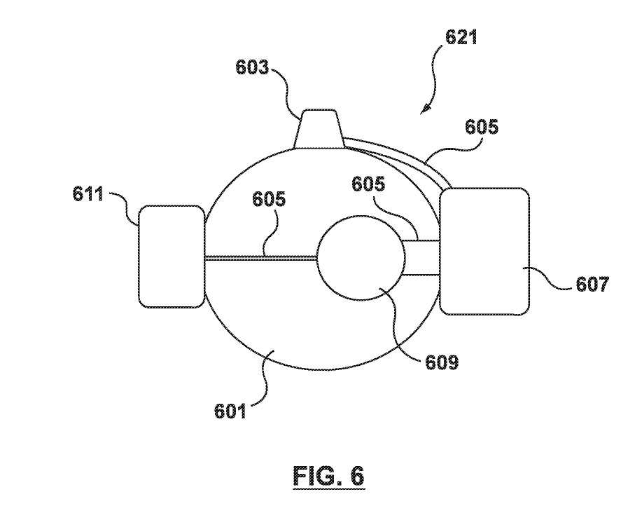

The scanning system may comprise a scanning laser range finder (SLRF) or an ultrasonic rangefinder (USRF), each of which scans the physical environment by emitting a signal, whether a laser beam or an ultrasonic signal, as the case may be, towards the physical environment. When the signal encounters an obstacle in the physical environment, the signal is reflected from the obstacle toward the scanning system. The scanning system either calculates the amount of time between emission and receipt of the signal, or the angle at which the signal returns to the scanner/range finder to determine the location of the obstacle relative to the scanning system. The scanning system may surround the HMD 12, as shown in FIG. 5, or atop the HMD, as shown in FIG. 6.

FIG. 6 shows another exemplary configuration for the HMD 621, in which some or all the systems of the HMD 621 are configured as removable modules. The HMD 621 comprises: a visor module 611 containing a display system, an imaging system and an IMU; a scanner module 603 containing a scanning system as well as, optionally, a stabiliser unit to stabilise the scanning system; a processor module 607 comprising a processor to perform some or all processing tasks required by the configuration; an audio module 609 having speakers and/or a microphone for audio input and output. Data and power cabling 605 links the various modules. The use of system modules to construct the HMD 621 may enable users to replace and/or remove inoperative, obsolete or redundant components, or to switch modules for other modules to provide different capabilities for interacting with a physical environment.

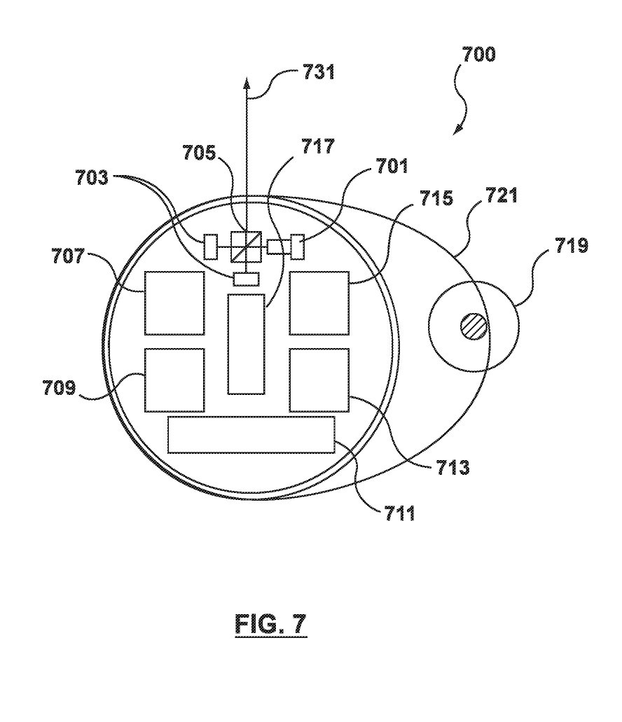

As described with reference to FIG. 6, the scanner module 603 may comprise the scanning system. An exemplary scanning system comprising an SLRF 700 is shown in FIG. 7. The SLRF 700 comprises a laser beam emitter to emit a laser beam 731, having at least one photo diode 703 for sensing the laser beam 731, a laser diode 701 for emitting the laser beam 731 and an optical beam splitter 705. The SLRF 700 further comprises: a laser driver 715 to modulate the laser beam 731; a power supply filter 713 to transform the voltage from a power supply to a voltage suitable for the components of the SLRF 700; support electronics 717, such as, for example, resistors, capacitors regulators, and other components that may be required in various SLRF configurations; a motor driver and optical encoder 711 to determine the angle of emission and reception of the laser beam 731; a time-of-flight integrated circuit (IC) 717 for measuring the time of travel of the laser beam 731; and micro-control unit (MCU) 709 to perform some or all the processing tasks required for scanning. The motor and encoder/stepper motor 7190 drives the laser beam transmitter about 360 degrees in order to provide full scanning about the HMD to which the SLRF 700 is to be mounted.

When the laser beam 731 is emitted, the time-of-flight IC records the departure angle and time; upon bouncing off an obstacle in the physical environment, the laser beam 731 is reflected back toward the SLRF 700 where it detected by at least one photo diode 703. The return time and angle are recorded, and the distance travelled is calculated by the MCU in conjunction with the time-of-flight IC. Alternatively, the laser beam 731, after being emitted, may encounter a receiver in the physical environment. The receiver signals receipt of the beam to the console, server, or processor in the HMD and the time of receipt is used to calculate the distance between the SLRF and the receiver in the environment, as hereinafter described. It will be appreciated that a USRF might operate in like manner with ultrasonic emission.

The SLRF 700 may comprise an optical beam splitter 705 in conjunction with two photodiodes 703 to serve one or more functions as described herein. First, scanning speeds may be doubled for any given rotation speed by splitting the laser beam 731 into two beams, each directed 180° away from the other. Second, scanning accuracy may be increased by splitting the beam into two slightly converging beams, such as, for example, by a fraction of one degree or by any other suitable angle. By directing two slightly diverging beams into the physical space, signal errors, distortions in the surface of any obstacles encountered by the beams, and other distortions may be detected and/or corrected. For instance, because the first and second slightly divergent beams should, in their ordinary course, experience substantially similar flight times to any obstacle (because of their only slight divergence), any substantial difference in travel time between the two beams is likely to correlate to an error. If the processor and/or time-of-flight IC detects a substantial difference in flight time, the processor and/or time-of-flight IC may average the travel time for the divergent beams or discard the calculation and recalculate the time-of-flight on a subsequent revolution of the emitter. Third, as shown in FIG. 7, scanning accuracy may be enhanced by splitting the beam into a first and a second beam, each representing, respectively, a start signal and a return signal. The beam splitter may direct the first beam towards one of the photo diodes, thereby indicating a start time; the beam splitter may further direct the second beam into the physical space, upon which the other photo diode will detect the reflection off an obstacle in physical space of the second beam and thereby indicating a return time. The processor, MCU and/or the time-of-flight IC may thereby calculate the time of flight as the difference between the start and return times.

The SLRF 700 may further comprise one-way optics for collimating the at least one laser beam as it is emitted, and converging returning laser beams.

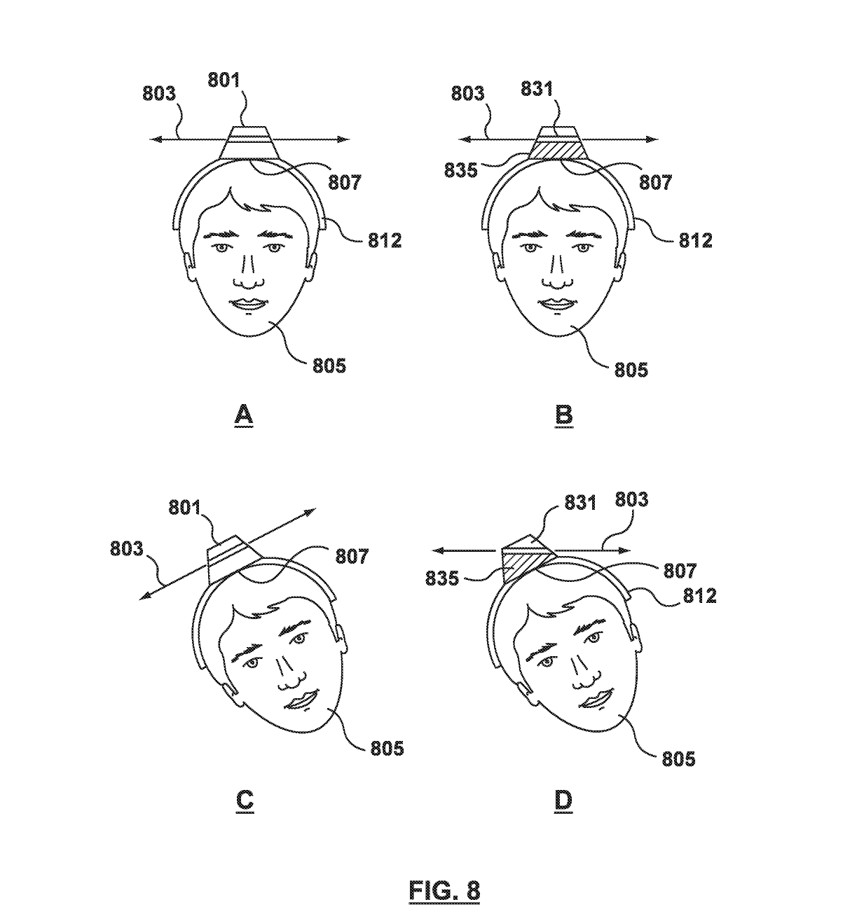

As previously outlined, the scanning system may be disposed upon an HMD worn by a user. However, it will be appreciated that a user moving throughout a physical environment is likely to move his head and/or body, thereby causing the HMD and, correspondingly, the scanning system to constantly move in 3 dimensions and about 3 axes, as shown in FIGS. 8A and C. These movements are prone to cause decreasing scanning accuracy. Therefore, the scanning system is preferably stabilised with a stabiliser unit.

As shown in FIGS. 8A and 8C, a scanning system 801 is mounted to the HMD 812 directly atop a user's head 805, i.e., without a stabiliser unit. The scanning system 801 transmits sound, laser or other suitable signal 803 substantially tangentially to the apex 807 of the user's head 805, as shown in FIG. 8A; however, as the user's head 805 moves, such as, for example, by tilting right, as shown in FIG. 8C, the beams 803 continue to emanate tangentially from the apex 807 of the user's head 805. The scanning system 801 will therefore capture a very different geometry of the physical environment, depending on the relative tilt of the user's head 805.

Therefore, as shown in FIGS. 8B and 8D, an HMD 812 may comprise a stabiliser unit 835 for mounting the scanning system 831 to the HMD 812. The stabiliser unit 835 enhances mapping and positional accuracy of inside-out or first-person view (FPV) mapping by ensuring that the scanning system 831 remains substantially level despite head movements of the user wearing the HMD 812.

The stabiliser unit 835 pivotally retains the scanning system 831 above the HMD 812. The scanning system 831 directs scanning beams 803 tangentially from the apex 807 of the user's head 805, i.e., level to the earth's surface, as in FIG. 8A, but now only when the user's head 805 is level. When the user tilts his head 805, as shown in FIG. 8D, the stabiliser unit 835 follows the user's head 805 in the same manner as the scanning system 801 described with reference to FIG. 8C. As shown in FIG. 8D, however, the scanning system 831 continues to direct scanning beams 803 parallel to the surface of the earth, but no longer tangentially to the apex 807 of the user's head 805. The stabiliser unit 835 ensures that the scanning plane of the scanning system 831 remains substantially level regardless of the tilt of the user's head 805. It will be appreciated, therefore, that inclusion of the stabiliser unit 835 in conjunction with the scanning system 831 may provide significant gains in mapping accuracy, since the scanning plane of a stabilised scanning system 831 will tend to vary less with a user's head tilt than the scanning plane of an unstabilised scanning system 801.

The stabiliser unit may comprise one or more of the following: a two- or three-axis gimbal for mounting the scanner; at least one motor, such as brushless or servo motors for actuating the gimbal; a gyroscope, such as a two- or three-axis gyroscope, or a MEMS gyroscope, for detecting the orientation of the scanner; and a control board for controlling the gimbal based on the detected orientation of the gyroscope.

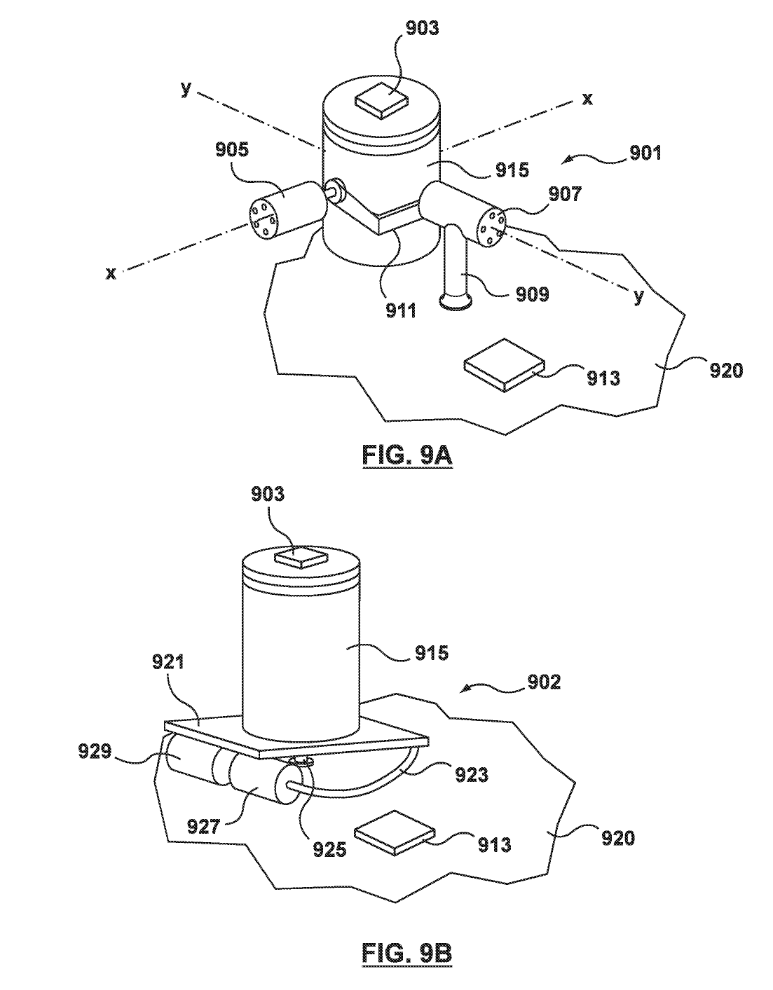

A stabiliser unit configuration is shown in FIG. 9A. The stabiliser unit 901 comprises a gyroscope 903 mounted atop the scanning system 915, first 905 and second 907 motors for rotating the scanning system about the x- and y-axes, respectively, of the scanning system 915, and a mount 909 for mounting the second motor 905 to the HMD 920, a partial view of which is shown. The gyroscope 903 may be of any suitable type, including, for example a MEMS-type gyroscope. The first 905 and second 907 motors are preferably coaxial with the respective x- and y-axis centres of mass of the scanning system. The first motor 905 is coupled to the scanning system 915 and to a bracket 911, while the second motor 907 is mounted to the HMD 920 and connected by the bracket 911 to the first motor. The second motor 909 rotates the bracket 911 about the second axis of rotation, thereby rotating both the scanning system 915 and the first motor 905, while the first motor 905 rotates the scanning system 915 about the x-axis of rotation. The motors are actuated by a processor in a control board 913, as shown, or in the processor of the HMD 920 based on the orientation of the scanning system 915 as determined by the gyroscope 903 in order to stabilise the scanning system 915.

An alternate stabiliser unit configuration is shown in FIG. 9B. The stabiliser unit 902 comprises a platform 921 pivotally mounted atop the HMD 920 for holding the scanning system 915. First 927 and second 929 coaxial motors are coupled to flexible or rigid motor-to-platform connectors, such as cams 923. The cams 923 are coupled to each side of the platform 921 and away from the pivotal connection 925 between the platform 921 and the HMD 920. As the motors 927 and 929 rotate their respective cams 923, the platform 921 tilts about its two axes. Other configurations are contemplated.

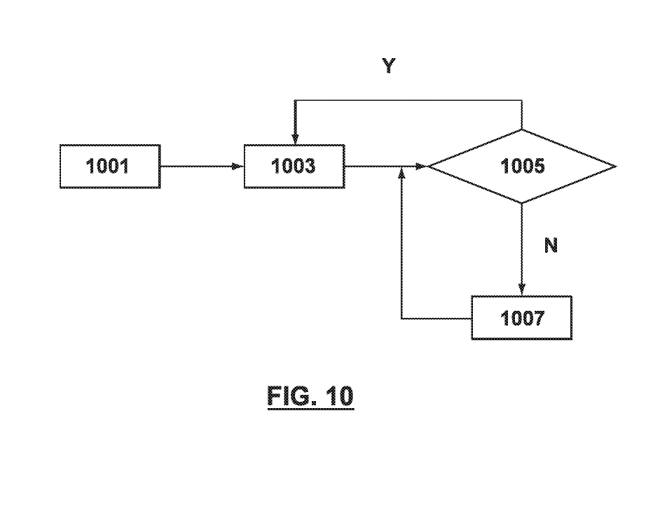

In embodiments, the scanning system only provides readings to the processor if the scanning system is level or substantially level, as determined by the method shown in FIG. 10. At block 1001, the gyroscope provides a reference reading for ‘level’. At block 1003, the gyroscope provides the actual orientation of the scanning system; if the scanning system's orientation is determined to be substantially level, at block, 1005, then its reading is provided to the processor; otherwise, the control board causes the gimbal motors to rotate to align the gimbals with a ‘level’ that is considered to be substantially level, at block 1007. When the control board determines that the scanning system is substantially level, its reading is provided to the processor, and the cycle begins anew at block 1003. Constant scanning via the scanning system of the HMD enables dynamic mapping of the physical environment in which the user is situated.

The control board may be any suitable type of control board, such as, for example, a Martinez gimbal control board. Alternatively, the stabiliser unit may delegate any controls processing to the processor of the HMD.

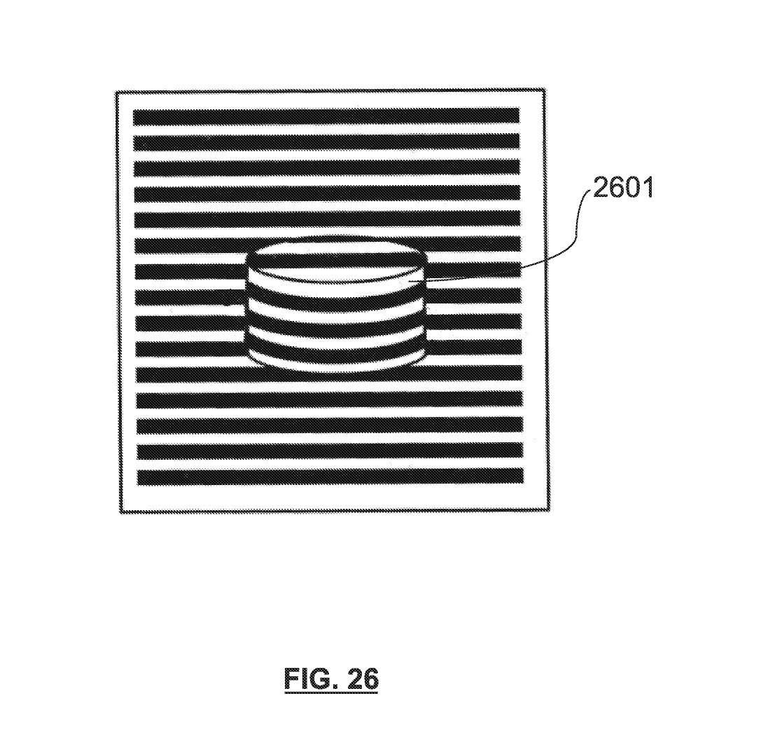

As shown in FIG. 26, the scanning system may implement structured-light 3D scanning, either in combination with, or alternatively to, other suitable scanning techniques, such as those described herein. An HMD configured to implement structured-light scanning may comprise a structured-light projector, such as, for example, a laser emitter configured to project patterned light into the physical environment. Alternatively, the structured-light projector may comprise a light source and a screen, such as a liquid crystal screen, through which the light source passes into the physical environment. The resulting light cast into the physical environment will therefore be structured in accordance with a pattern. As shown in FIG. 26, the structured-light projector may emit light as a series of intermittent horizontal stripes, in which the black stripes represent intervals between subsequent projected bands of light. The scanning system may further comprise a camera operable to capture the projected pattern from the physical environment. A processor, such as a processor on the HMD, is configured to determine topographies for the physical environment based on deviations between the emitted and captured light structures. For a cylinder 2601, as shown in FIG. 26, a stripe pattern projected from the structured-light projector will deviate upon encountering the surface of the cylinder 2601 in the physical environment. The structured light camera captured the reflected pattern from the cylinder and communicates the captured reflection to the processor. The processor may then map the topography of the cylinder by calculating the deviation between the cast and captured light structure, including, for example, deviations in stripe width (e.g., obstacles closer to the scanning system will reflect smaller stripes than objects lying further in the physical environment, and vice versa), shape and location. Structured-light scanning may enable the processor to simultaneously map, in 3 dimensions, a large number of points within the field of view of the structured light scanner, to a high-degree of precision.

While the scanning system performs scanning for mapping the physical environment, the HMD comprises a local positioning system (LPS) operable to dynamically determine the user's position in 2D or 3D within the physical environment. The LPS may invoke one or more ultrasonic, radio frequency (RF), Wi-Fi location, GPS, laser range finding (LRF) or magnetic sensing technologies. Further, the scanning system and the LPS may share some or all components such that the same system of components may provide serve both scanning and positioning functions, as will be appreciated.

The LPS may comprise at least one LPS receiver placed on the HMD or the user's body and operable to receive beacons from LPS emitters placed throughout the physical environment. The location for each LPS emitter is known. The LPS calculates the distance d travelled by each beam from each LPS emitter to the at least one LPS receiver on the user's body according to time-of-flight or other wireless triangulation algorithms, including, for example, the equation d=C·t, where C is a constant representing the speed at which the beam travels and t represents the time elapsed between emission and reception of the beam. It will be appreciated that the constant C is known for any given beam type; for a laser beam, for example, C will be the speed of light, whereas for an ultrasonic beam, C will be the speed of sound. Upon thereby calculating the distance between the at least one LPS receiver and at least three LPS emitters disposed at known, and preferably fixed, positions in the physical environment, the LPS trilaterates the distances to determine a location for the user and her HMD in the physical environment. Although at least three receivers are required for determining the local position of a user, increasing the number of receivers within the physical environment results in greater accuracy.

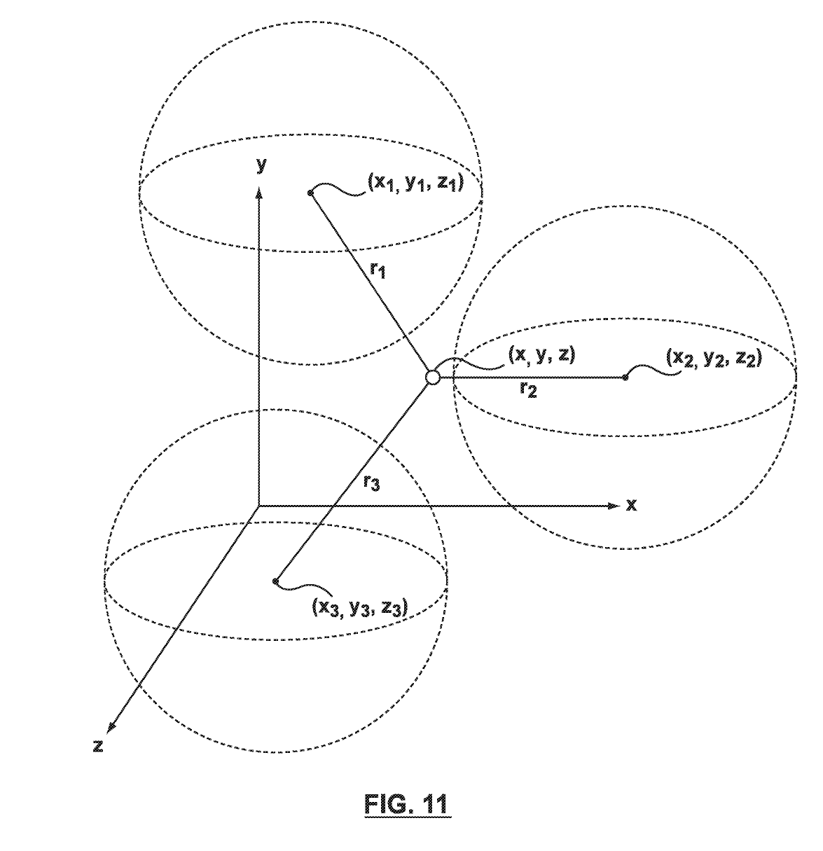

Trilateration involves determining the measured distances between the LPS receivers and the LPS transmitter, using any of the above described techniques, and solving for the location of the LPS based on the distances and the known locations of the LPS receivers. As shown in FIG. 11, for any number n of LPS emitters, where n≧3, in the physical environment, each having coordinates (xₙ, yₙ, zₙ) the processor calculates the user's position (x, y, z) as the intersection point of n spheres each of which is centred on the world space coordinates for each LPS emitter, where each sphere corresponds to the spherical equation (x−xₙ)²+(y−yₙ)²+(z−zₙ)²=rₙ. It will be appreciated that r corresponds to the radius of the sphere, which equals the distance from each LPS emitter to the LPS receiver. The processor may then solve the n spherical equations with the known coordinates of each of the LPS emitters, as well as the known distances between the LPS and the LPS emitters r₁, r₂ . . . rₙ to determine the user's position:

$$\begin{matrix}{( x - {x}_{1} )}^{2} + {( y - {y}_{1} )}^{2} + {( z - {z}_{1} )}^{2} = {r}_{1}^{2} \\ {( x - {x}_{2} )}^{2} + {( y - {y}_{2} )}^{2} + {( z - {z}_{2} )}^{2} = {r}_{2}^{2} \\ … \\ {( x - {x}_{n} )}^{2} + {( y - {y}_{n} )}^{2} + {( z - {z}_{n} )}^{2} = {r}_{n}^{2}\end{matrix}$$

Each user's position, once determined by the LPS, may then be shared with other users in the physical environment by transmitting the position to the central console or directly to the HMDs of other users. When multiple users occupying the same physical environment are equipped with HMDs having local positioning functionality configured to share each user's positions with the other users, some or all of the users may be able determine where other users are located within the environment. Users' respective HMDs may further generate renderings of an AR version of the other users for viewing by the respective user, based on the known locations for the other users.

While the LPS has been described above with reference to the LPS emitters being located in the physical environment and the LPS receivers being located on the user's body or HMD, the LPS emitters and LPS receivers could equally be reversed so that the LPS receivers are located within the physical environment and at least one LPS emitter is located on the user's body or HMD.

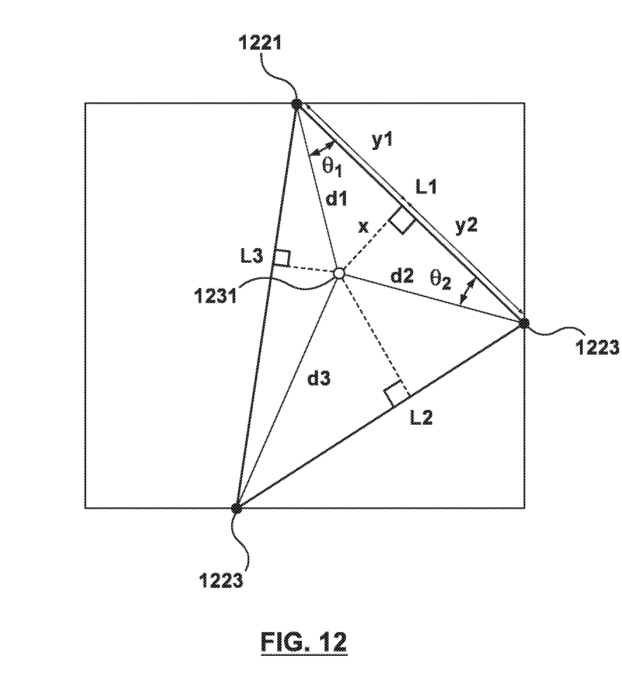

As previously, described with reference to the SLRF of FIG. 7, the LPS may emit beams into the physical environment and detect them as they return. Alternatively, at least three emitters 1221, 1222, 1223 may be mounted at known locations in the physical environment, and the HMD may comprise a receiver 1231 configured to detect signals from the emitters 1221, 1222 and 1223, as shown in FIG. 12. Because the locations are known for the emitters 1221, 1222 and 1223, the distances L₁, L₂, L₃ and angles between the emitters 1221, 1222 and 1223 are known. Further, the distances d₁, d₂ and d₃ between the receiver 1231 and the emitters 1221, 1222 and 1223 are determined by calculating the time-of-flight of the signals between the emitters and the receiver. The processor then solves the following equations to determine the angles θ₁, θ₂ and θ₃ between the signals and the triangle formed between the emitters:

$${y}_{1}^{2} + {x}_{12}^{2} = {d}_{1}^{2} {y}_{2}^{2} + {x}_{12}^{2} = {d}_{2}^{2}$$

$${x}_{12}^{2} = {d}_{1}^{2} - {y}_{1}^{2} {x}_{12}^{2} = {d}_{2}^{2} - {y}_{2}^{2}$$

$${d}_{1}^{2} - {y}_{1}^{2} = {d}_{2}^{2} - {y}_{2}^{2}$$

$${d}_{1}^{2} - {d}_{2}^{2} = {y}_{1}^{2} - {y}_{2}^{2} , where {L}_{1} = {y}_{1} + {y}_{2}$$

$${y}_{2} = {L}_{1} - {y}_{1}$$

$${d}_{1}^{2} - {d}_{2}^{2} = {y}_{1}^{2} - {( {L}_{1} - {y}_{1} )}^{2}$$

$$\vert {y}_{1}^{2} - {y}_{1} + \frac{{d}_{2}^{2} - {d}_{1}^{2} + {L}_{1}^{2}}{2} \vert = 0$$

By solving analogous versions of the last quadratic equation for each of y₁, y₂, and y₃, it will be appreciated that the processor will then have sufficient information to determine the location for the receiver 1231.

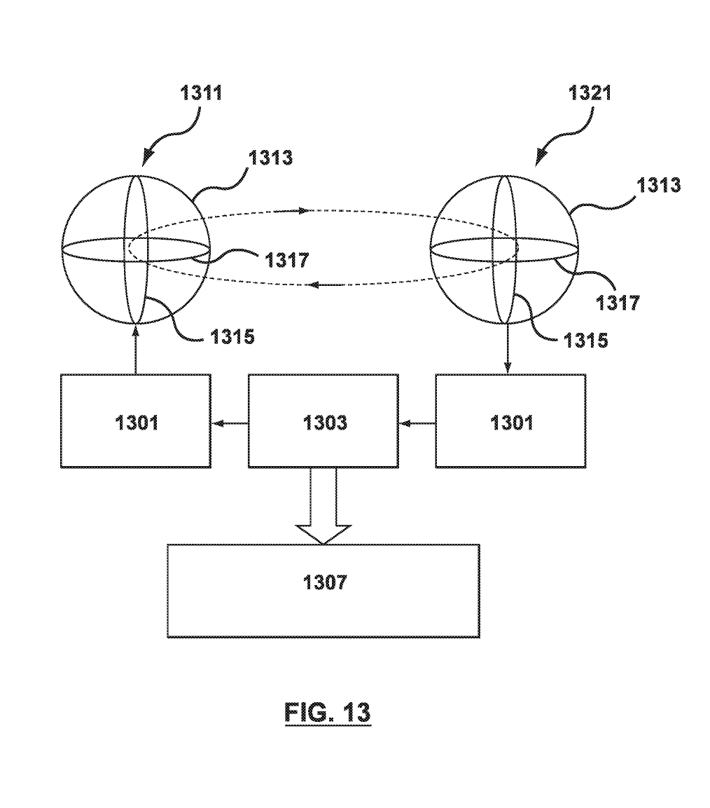

Referring now to FIG. 13, the LPS may further, or alternatively comprise a 3-axis magnetic sensor 1321 disposed on an HMD and configured to detect the relative position of a 3-axis magnetic source 1311 located at a base position having known coordinates in the physical space. The 3-axis magnetic source 1311 and magnetic sensor 1321 may each comprise three orthogonal coils 1313, 1315 and 1317 driven by an amplifier 1301 to generate and receive, respectively, an active AC magnetic field acting as a coupling, as shown by the stippled line. The magnetic source emits an AC magnetic field. When the magnetic sensor 1321 encounters the magnetic field, the magnetic sensor 1311 measures the strength and orientation of the magnetic field. The processor 1303 uses that information to determine the relative distance and orientation from the magnetic source 1311 to the magnetic sensor 1321. The determination and/or information may be distributed to other system components via communication module 1307.

The use of 3-axis magnetic fields to provide local positioning may provide numerous advantages, including, for example:
1. Elimination of line-of-sight restrictions common to other local positioning techniques;
2. Elimination of drift due to the fixed and known location of the base position;
3. Simple extension of coverage across larger or complicated physical environments by adding 3-axis relative sources at disparate locations;
4. High positional accuracy (e.g., within millimetres);
5. Mitigation of health hazards due to radiation; and
6. Enhanced modularity—a single source can cooperate with multiple sensors.

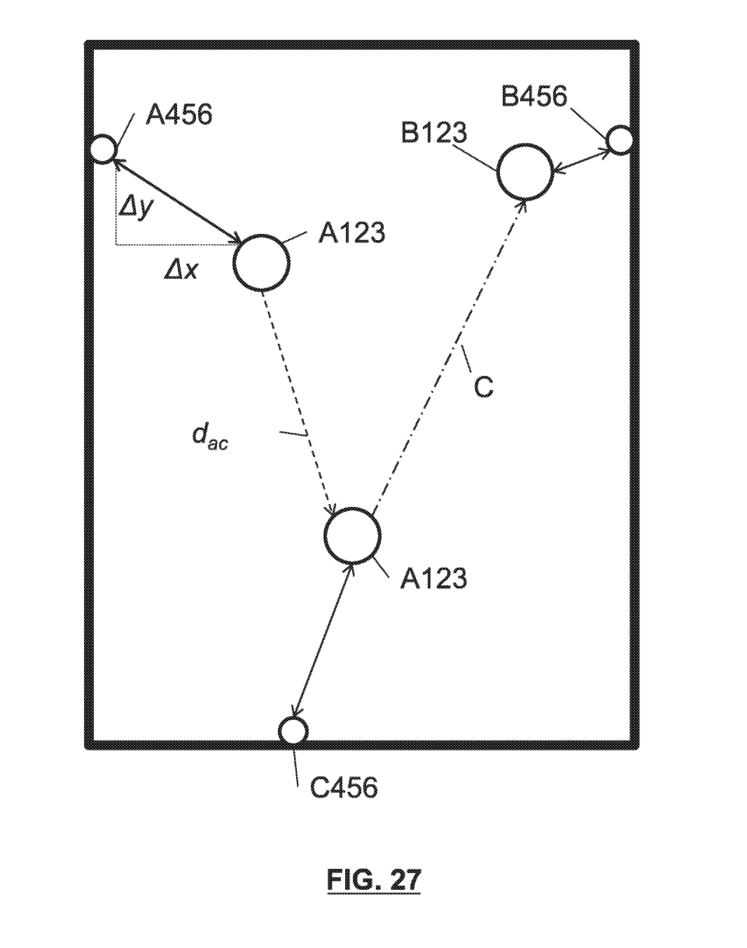

Referring now to FIG. 27, an exemplary scenario is illustrated in which a first user and second user are situated in a physical environment. The first user is equipped with a first HMD having a receiver with a unique ID A123; the second user is equipped with a second HMD having a receiver with a unique ID B123. Initially, the first user is within line-of-sight of a first emitter with a unique ID A456, and the second user is within line-of-sight of a first emitter with a unique ID B456. If the first user moves along the trajectory d_{ac}, as shown, so that the receiver with the unique ID A123 comes into proximity of a third emitter having a unique ID C456, the first user's HMD may communicate an updated location for the HMD to the second user's HMD according to any suitable communication signal C. The emitter and receiver configuration shown in FIG. 28 is illustrative of a configuration in which the relative location of each may be determined with reference to a single one of the other. For example if the emitter is a 2- or 3-axis magnetic source and the receiver is a 2- or 3-axis magnetic sensor, a paired combination of one emitter and one receiver may provide, respectively, relative 2- or 3-dimensional displacement measurements, such as, for example, Δx and Δy as shown. However, each HMD may communicate changes in position within the physical environment to the other HMD in a configuration in which sets of three emitters are located throughout the physical environment. For example, if each of the emitters shown in FIG. 28 instead consists of a three-emitter array, each user's position could be determined by triangulation or trilateration, as previously described. In either configuration, the change in location of the first user may be communicated to the HMD of the second user. Further, the configuration shown may be modified if each HMD communicates with a console or external processor. It will be understood that the change in location of the first user may be communicated to the console and relayed to the HMD of the second user. Further, although only three emitters and two receivers are shown, the number of emitters and receivers may be greater, providing location sharing between a plurality of users moving throughout a physical environment with a plurality of locations. The use of an emitter or emitters having known locations within a physical environment to locate a receiver within the physical environment may be referred to as active reference positioning or markered reference positioning. If the physical environment shown in FIG. 27 is divided into regions, for example by walls, such that the first user moves from one room to another in the above scenario, a single emitter and receiver combination may provide the location of the HMD with reference to a room, but the location within that room.

As explained herein in greater detail, each emitter may emit a modulated signal and a corresponding receiver may detect and demodulate the signal to obtain metadata for the signal. For example, a receiver on an HMD may detect a modulated IR signal emitted from an IR emitter in the physical environment. The modulated signal may be emitted at a given frequency; correspondingly, the receiver may be configured to detect the frequency, and a processor may be configured to extract metadata for the signal based on the detected frequency. The metadata may correlate to the coordinates of the emitter within the physical space, or the unique ID for the emitter. If the metadata does not comprise location information for the emitter, but it does comprise the unique ID for the emitter, the processor may generate a query to a memory storing the locations for the emitters in the physical environment. By providing the ID information extracted from the IR signal, the processor may obtain the location information associated with the ID from memory. Signal modulation systems and methods are described herein in greater detail.

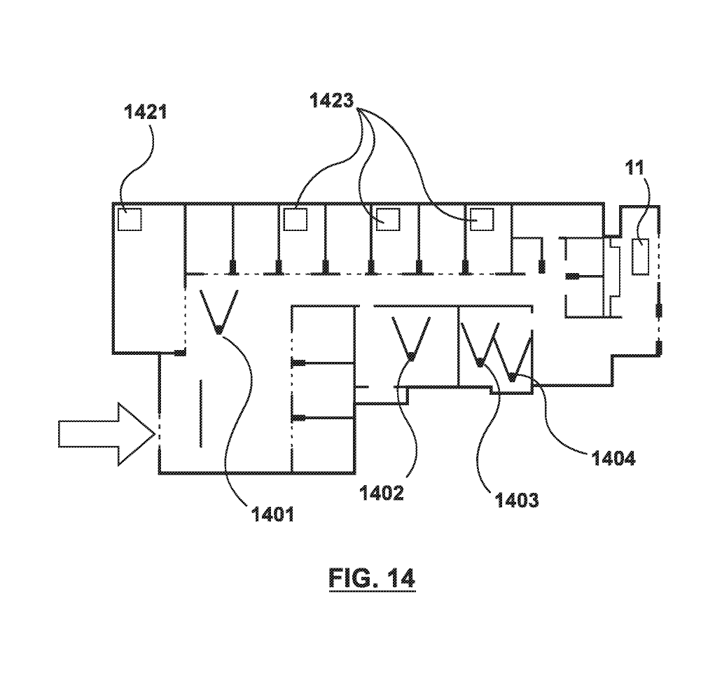

It will be appreciated that many physical environments, such as, for example, a building with a plurality of rooms, contain obstacles, such as walls, that are prone to break the path travelled by an emitted beam of an LRF. In such environments, ultrasonic or magnetic positioning may provide advantages over laser positioning, since ultrasonic signals may be suited to transmission irrespective of line of sight. As shown in FIG. 14, an SLRF may be used for mapping while an LPS comprising ultrasonic positioning is used for positioning HMDs in the physical space. In multi-room applications, each room may comprise at least three ultrasonic emitters 1423, and each user's HMD 1401, 1402, 1403 and 1404 may comprise at least one ultrasonic receiver to detect ultrasonic signals from the ultrasonic emitters 1423. An ultrasonic emitter 1421 situated at a known location in one of the rooms may serve as a reference point for the remaining emitters 1423 in the physical space. A console 11 or other suitable processor may determine, based on known locations for at least three ultrasonic emitters 1423, the physical locations of the remaining sets of at least three emitters 1423 located elsewhere in the physical environment if the emitters 1423 are configured to emit and receive ultrasonic signals. For example, if the ultrasonic emitters 1423 are provided as ultrasonic transceivers, the locations of each emitter 1423 in the physical space may be obtained based on the reference emitter 1423 by any suitable techniques, including, for example, transponders or ultrasonic emitter-to-ultrasonic receiver-to-ultrasonic emitter positioning. Multi-room engagement with the physical environment may thereby be enabled.

In embodiments, a scanning laser range finder may serve as the positioning and scanning system. For example, an SLRF may provide scanning, as previously described, as well as positioning in cooperation with emitters and/or receivers placed at known locations in the physical space. Alternatively, once the processor has generated the initial map for the physical space based on readings provided by the SLRF, subsequent dynamic SLRF scanning of the physical space may provide sufficient information for the processor to calculate the position and orientation of the HMD comprising the SLRF with reference to changes in location of mapped features of the physical environment. For example, if the map for the physical environment, which was generated based on the SLRF having an initial orientation θ_{SLRF} and initial coordinates in world space X_{SLRF}, Y_{SLRF}, comprises a feature having world coordinates X, Y the processor may determine an updated location X_{SLRF}′, Y_{SLRF}′ and orientation θ_{SLRF}′ for the HMD based on any changes in the relative location of the feature.

Further, the LPS may comprise ultrasonic, laser or other suitable positioning technologies to measure changes in height for the HMD. For example, in a physical environment comprising a ceiling have a fixed height, an ultrasonic transmitter/emitter directed towards the ceiling may provide the height of the HMD at any time relative to a height of the HMD at an initial reading. Alternatively, the height of the HMD may be determined by equipping a user equipped with a magnetic positioning system with either of a magnetic emitter or a magnetic sensor near her feet and the other of the magnetic emitter or magnetic sensor on her HMD and determining the distance between the magnetic emitter and magnetic sensor.

The HMD may further comprise a 9-degree-of-freedom (DOF) inertial measurement unit (IMU) configured to determine the direction, orientation, speed and/or acceleration of the HMD and transmit that information to the processor. This information may be combined with other positional information for the HMD as determined by the LPS to enhance location accuracy. Further, the processor may aggregate all information relating to position and motion of the HMD and peripherals to enhance redundancy and positional accuracy. For example, the processor may incorporate data obtained by the scanning system to enhance or supplant data obtained from the LPS. The positions for various peripherals, including those described herein, may be determined according to the same techniques described above. It will be appreciated that a magnetic positioning system, such as described herein, may similarly provide information to the processor from which the direction, orientation, speed and/or acceleration of the HMD and other components and/or systems equipped therewith, instead of, or in addition to other inertial measurement technologies. Therefore, it will be understood that the inertial measurement unit may be embodied by an LPS invoking magnetic positioning.

As previously described, and as will be appreciated, the outputs of the LPS, the IMU and the scanner are all transmitted to the processor for processing.

AR rendering of the physical environment, which occurs in the processor, may further comprise obtaining imaging for the physical environment; however, it will be understood that a user may engage with an AR based on the physical environment without seeing any imaging for the physical environment. For example, the AR may contain only virtual renderings of the physical, although these may be modelled on the obstacles and topography of the physical environment. In embodiments, the degree to which the AR comprises images of the physical environment may be user-selectable or automatically selected by the processor. In yet another embodiment, the display system comprises a transparent or translucent screen onto which AR image streams are overlayed, such that the AR presented to a user may incorporate visual aspects of the physical environment without the use of an imaging system. This may be referred to as “see-through” AR. See-through AR may be contrasted with “pass-through” AR, in which an imaging system to capture an image stream of the physical environment electronically “passes” that stream to a screen facing the user. The HMD may therefore comprise an imaging system to capture an image stream of the physical environment.

The processor renders computer generated imaging (CGI) which may comprise an overlay of generated imaging on a rendering of the physical environment to augment the output of the imaging system for display on the display system of the HMD. The imaging system may comprise at least one camera, each of which may perform a separate but parallel task, as described herein in greater detail. For example, one camera may capture standard image stream types, while a second camera may be an IR camera operable to “see” IR beams and other IR emitters in the physical environment. In an exemplary scenario, the IR camera may detect an IR beam “shot” between a first and second player in a game. The processor may then use the detection as a basis for generating CGI to overlay on the IR beam for display to the user. For example, the processor may render the “shot” as a green beam which appears on the user's display system in a suitable location to mimic the “shot” in the rendering of the physical environment. In embodiments, elements, such as, for example, other users' peripherals, may be configured with IR LEDs as a reference area to be rendered. For example, a user may be equipped with a vest comprising an IR LED array. When the user is “shot”, the array is activated so that other users' HMDs detect, using monochrome cameras, the IR light from the array for rendering as an explosion, for example. Through the use of multiple cameras operable to capture different types of light within the physical environment, the processor may thereby render a highly rich and layered AR environment for a given physical environment.

The at least one camera of the imaging system may be connected to the processor by wired or wireless connections suitable for video streaming, such as, for example, I2C, SPI, or USB connections. The imaging system may comprise auto focus cameras each having an external demagnification lens providing an extended wide filed-of-view (FOV), or cameras having wide FOV fixed focus lenses. The imaging system may capture single or stereo image streams of the physical environment for transmission to the processor.

Each camera may further be calibrated to determine its field-of-view and corresponding aspect ratio depending on its focus. Therefore, for any given camera with a known aspect ratio at a given focal adjustment, the processor may match the screen and camera coordinates to world coordinates for points in an image of the physical environment.

As shown in FIG. 5, the HMD 12 may comprise a processing unit 130 to perform various processing functions, including mapping, imaging and rendering, and, in aspects, mediation of game play parameters and interactions with other users and their respective HMDs and peripherals; alternatively, the central console 11 shown in FIG. 3 may mediate the game play parameters and interactions between all the users and their respective HMDs and peripherals in the system. Various HMDs and their respective peripherals may either share the central console to globally AR render the physical environment, or each HMD may comprise an onboard graphics processor to independently render the AR scene for the physical environment. Either way, multiple users may experience the same AR rendering of the physical environment, or each user may experience an individually tailored rendering of the physical environment.

The processor may collect data from the other components described herein, as shown in FIG. 2, including, for example, the camera system, the LPS and the scanning system to generate and apply AR renderings to captured image streams of the physical environment. The processor then transmits the rendered representation of the physical environment to the display system of the at least one HMD for display to the respective users thereof.

In an exemplary scenario as shown in FIG. 14, four users explore the physical environment shown. Each user is equipped with an HMD 1401, 1402, 1403 and 1404 comprising a mapping system to scan the area in which he or she is situated. Each HMD may independently map the area scanned by its respective mapping system, or the mapping systems of all the HMDs may contribute their respective scans to a shared processor, such as, for example in the console, for shared mapping of the physical environment. The processor then uses the obtained map or maps to AR render the physical environment, as well as manage game play parameters common to the users 1401, 1402, 1403 and 1404 and coordinate the users' respective positions within the physical environment.

As previously described, all processing tasks may be performed by one or more processors in each individual HMD within a physical environment, or processing tasks may be shared with the server, the console or other processors external to the HMDs.

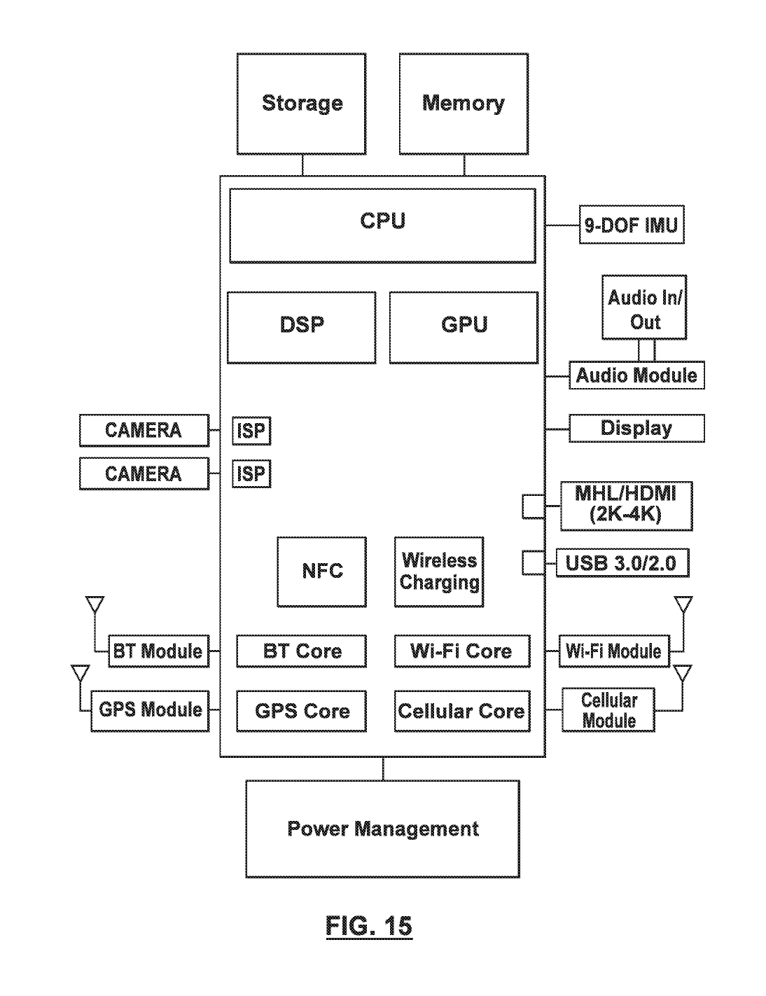

In at least one exemplary configuration for a processor, as shown in FIG. 15, the processor may comprise a CPU, a digital signal processor (DSP), a graphics processing unit (GPU), an image signal processor (ISP), a near-field communication unit, wireless charging, a Wi-Fi core, a Bluetooth code (BT core), a GPS core and/or a cellular core. The processor may communicate through the various sub-processors and cores with cameras, a Bluetooth module for Bluetooth communication, a GPS module, a cellular module, a Wi-Fi module, a USB connection, an HDMI connection, a display, an audio module having audio input/output capabilities, a 9 DOF IMU, storage, a memory, and a power management module for managing and transmitting power from, for example, a battery. It will be appreciated then, that the processor may enable communication between the components of the AR system, as well as perform tasks and calculations related to the tasks carried out by each of the components.

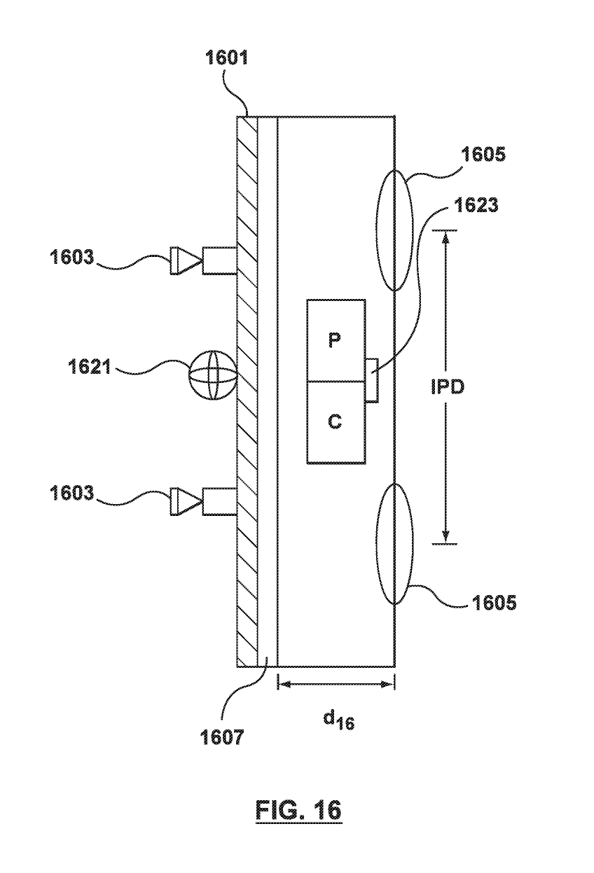

The processor may be a mobile computing device, such as a laptop, a mobile phone or a tablet. Alternatively, the processor may be a microprocessor onboard the HMD. In embodiments, as shown in FIG. 16, the processor 1601, the display system and imaging system may form a single module which can be easily removed from the HMD for replacement when desired. As shown, the imaging system comprises at least a first and second camera 1603 for capturing image streams of a physical environment. The processor 1601 is adjacent to the at least first and second cameras 1603 and is further backed by a screen 1607 of the display system. At least two lenses 1605 stand opposite and parallel to the screen 1607 at a preferably adjustable distance d₁₆. The lenses 1605 enhance user perception of the images shown on the screen, for example, by mirroring the filed-of-view of the cameras 1603; the distance between the lenses 1605 is preferably adjustable to accommodate various interpupillary distances (IPD) for different users.

Regardless of the physical configuration of the at least one processor, processing to AR render the physical environment in which at least one user is situated may comprise generating AR graphics, sounds and other sensory feedback to be combined with the actual views of the physical environment for engaging with the at least one user.

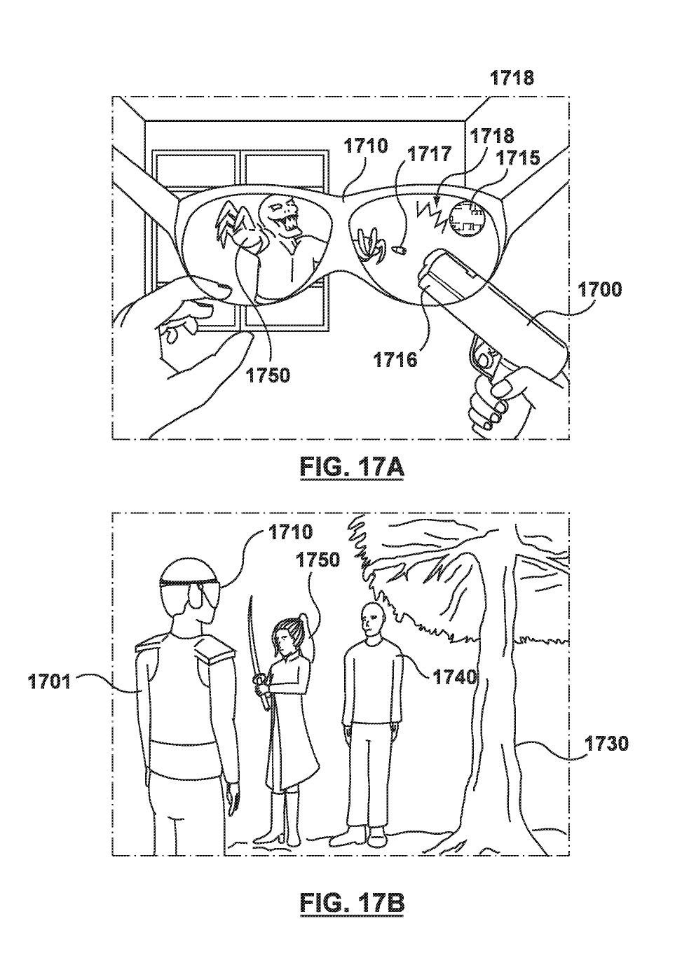

Referring to FIGS. 17A and 17B, exemplary user perceptions of augmented physical environments are illustrated in which AR rendering of the physical environment comprises: modelling 3D animated imagery, such as, for example, characters, weapons, and other effects; and combining the 3D animated imagery with the captured images of the physical environment. The processor causes the display system 1710 to display a given 3D animated object, such as a zombie 1750, at a location in display coordinates corresponding to the location in the global coordinates of the physical environment where the user 1701 is meant to perceive the object as being located. The display system 1710 of an HMD may thereby display the AR rendered physical environment with enhanced game play parameters, such as, for example, level progressions, missions, characters, such as, for example, “zombies” 1750 and progressive scenery, such as, for example a tree 1730, as shown in FIG. 17B. Further examples of game play parameters which the processor may be operable to render include: colour wheel 1715, which provides a viewing pane in the display system 1710 for displaying to the user 1701 when she has fired her peripheral gun 1700; the virtual trajectory of a “bullet” 1717 fired from the barrel 1716 of the user's peripheral gun 1700; and smoke or a spark 1718 caused by the firing of the “bullet” 1717. Further, the image of the zombie 1750 displayed in the display system 1710 of the user's HMD may be an AR representation of another user 1740 or 1750 visible within the physical environment.

Other possible augmentation may include applying environmental layers, such as, for example, rain, snow, fog and smoke, to the captured images of the physical environment. The processor may even augment features of the physical environment by, for example, rendering topographical features to resemble rugged mountains, rendering barren “sky” regions as wispy clouds, rendering otherwise calm water bodies in the physical environment as tempestuous seas, and/or adding crowds to vacant areas.

Expression based rendering techniques performed by the processor may be invoked to automate graphical animation of “living” characters added to the AR rendering. For example, characters may be rendered according to anatomical models to generate facial expressions and body movements.

The processor may further invoke enhanced texture mapping to add surface texture, detail, shading and colour to elements of the physical environment.

The processor may comprise an image generator to generate 2D or 3D graphics of objects or characters. It will be appreciated that image generation incurs processing time, potentially leading to the user perceiving lag while viewing the AR rendered physical environment. To mitigate such lag, the processor buffers the data from the at least one camera and rendering the buffered image prior to causing the display system to display the AR rendered physical environment to the user. The image generator preferably operates at a high frequency update rate to reduce the latency apparent to the user.

The image generator may comprise any suitable engine, such as, for example, the Unity game engine or the Unreal game engine, to receive an image feed of the physical environment from the imaging system and to generate AR and/or VR objects for the image feed. The image generator may retrieve or generate a wire frame rendering of the object using any suitable wire frame editor, such as, for example, the wire frame editor found in Unity. The processor further assigns the object and its corresponding wire frame to a location in a map of the physical environment, and may determine lighting and shading parameters at that location by taking into account the shading and lighting of the corresponding location in the image stream of the physical environment. The image generator may further invoke a suitable shading technique or shader, such as, for example, Specular in the Unity game engine, in order to appropriately shade and light the object. Examples such as shadows can be filtered out through mathematical procedures. The processor may further generate shading and lighting effects for the rendered image stream by computing intensities of light at each point on the surfaces in the image stream, taking into account the location of light sources, the colour and distribution of reflected light, and even such features as surface roughness and the surface materials.

The image generator is further operable to generate dynamic virtual objects capable of interacting with the physical environment in which the user is situated. For example, if the image generator generates a zombie character for the AR rendered physical environment, the image generator may model the zombie's feet to interact with the ground on which the zombie is shown to be walking. In an additional exemplary scenario, the processor causes a generated dragon to fly along a trajectory calculated to avoid physical and virtual obstacles in the rendered environment. Virtual scenery elements may be rendered to adhere to natural tendencies for the elements. For example, flowing water may be rendered to flow towards lower lying topographies of the physical environment, as water in the natural environment tends to do. The processor may therefore invoke suitable techniques to render generated objects within the bounds of the physical environment by applying suitable rendering techniques, such as, for example, geometric shading.

The processor, then, may undertake at least the following processing tasks: it receives the image stream of the physical environment from the imaging system to process the image stream by applying filtering, cropping, shading and other imaging techniques; it receives data for the physical environment from the scanning system in order to map the physical environment; it receives location and motion data for the at least one user and the at least one device location in the physical environment to reflect each user's interaction with the physical environment; it computes game or other parameters for the physical environment based on predetermined rules; it generates virtual dynamic objects and layers for the physical environment based on the generated map of the physical environment, as well as on the parameters, the locations of the at least one user and the at least one device in the physical environment; and it combines the processed image stream of the physical environment with the virtual dynamic objects and layers for output to the display system for display to the user. It will be appreciated throughout that the processor may perform other processing tasks with respect to various components and systems, as described with respect thereto.

When a user equipped with an HMD moves throughout the physical environment, the user's HMD captures an image stream of the physical environment to be displayed to the user. In AR applications, however, AR layers generated by the processor are combined with the image stream of the physical environment and displayed to the user. The processor therefore matches the AR layers, which are rendered based at least on mapping, to the image stream of the physical environment so that virtual effects in the AR layers are displayed at appropriate locations in the image stream of the physical environment.

In one matching technique, an imaging system of an HMD comprises at least one camera to capture both the image stream of the physical environment, as well as “markers” within the physical environment. For example, the at least one camera may be configured to detect IR beams in the physical environment representing a “marker”. If the imaging system comprises multiple cameras, the cameras are calibrated with respect to each other such that images or signals captured by each camera are coordinated. In applications where the processor renders AR effects for IR beams, then, the processor may only need to combine the AR stream with the image stream for display in order to effect matching. Alternatively, the processor may need to adjust the AR stream based on known adjustments to account for different perspectives of each of the cameras contributing data to the processor.

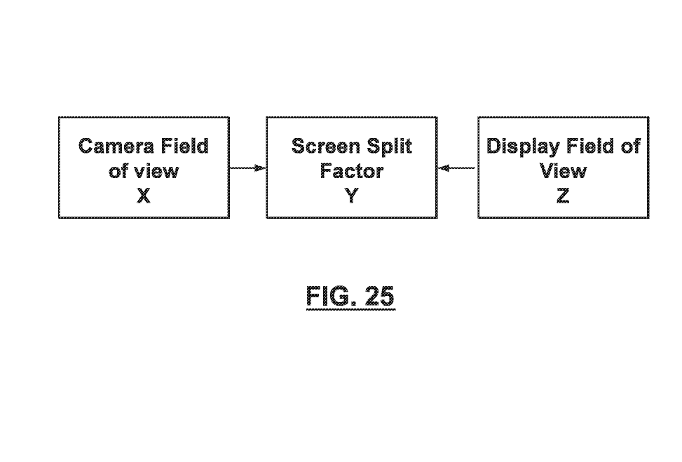

In another matching technique, matching may be markerless, and the processor may use location, orientation and motion data for the HMD and other system components to perform matching. Markerless matching is illustrated in FIG. 25. As previously described, AR rendering may comprise generation of CGI for a map of the physical environment. By determining the orientation, location, and velocity of the user's HMD, as well as parameters for the HMD's imaging system, the processor may match the image stream of the physical environment to the map-based AR layers according to the equations:

X=ƒ(Y,screen aspect ratio,camera aspect ratio), and

Z=ƒ(Y,magnification,screen aspect ratio).

Y is the screen spit factor, which accounts for the distortion of the screen aspect ratio relative to the camera aspect ratio and is known for a system having fixed lenses and displays; Y is fixed for a given screen; X represents the camera field of view; and Z represents the screen field of view. The processor, then, associates screen coordinates to the world coordinates of the field of view captured by the at least one camera of the imaging system. Using the orientation and location of the HMD, the processor may determine the orientation and location of the field of view of the at least one camera and determine a corresponding virtual field of view having the same location and orientation in the map of the physical environment. Using the equations described immediately above, the processor then determines the screen coordinates for displaying the rendered image on the screen having screen split factor Y.

The display system of the HMD may comprise a display surface, such as an LCD, LED display, OLED display or other suitable electronic visual display to display image streams to the user. Additionally and alternatively, the display surface may consist of transparent, translucent, or opaque material onto which image streams are projected from a projector located elsewhere on the HMD. The display system may provide heads-up notifications generated by the processor. A user wearing the HMD may view her surrounding physical environment as an unaltered or augmented reality environment displayed on the display surface. Further, in applications where engagement with the user's physical surroundings is not required, the display system of the HMD may simply display VR or other streams unrelated to AR rendering of the physical environment in which the user is situated.

Input to the display system may be in one or more suitable formats, such as, for example, HDMI, mini HDMI, micro HDMI, LVDS, and MIPI. The display system may further accept input from various external video inputs, such as television boxes, mobile devices, gaming consoles, in various resolutions, such as, for example, 720p, 1080p, 2K and 4K.

The real-time image on the display system of the HMD may be replicated to an external output device, such as, for example, a monitor or television, for bystanders or other parties to see what the wearer of the HMD is seeing.

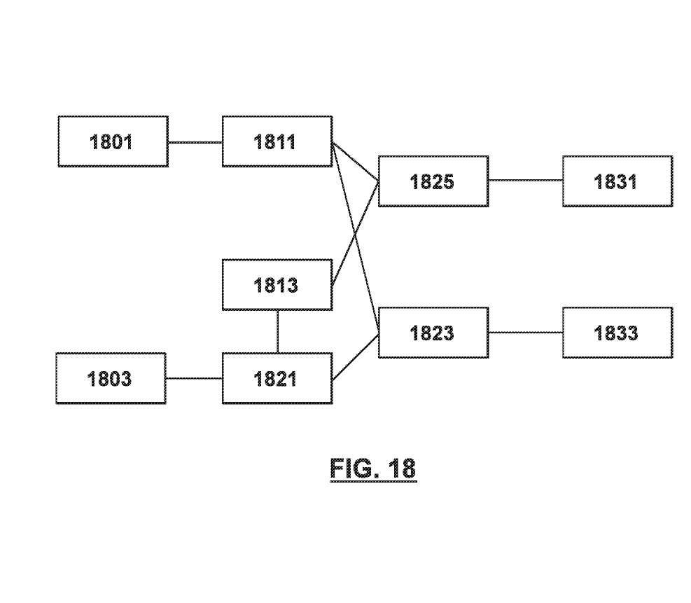

As shown in FIG. 18, a system is illustrated for receiving in an HMD multiple input signals and signal types, combining the signals and providing the combined signals to multiple display devices. As described herein, the HMD may have its own video source 1801 providing a rendered image stream to display the AR rendered physical environment to the user. Concurrently, however, the HMD may receive video input from an external source 1803, such as, for example, a controller, or the console, to overlay into the HMD video.

If, as illustrated, the HMD display system 1831 is configured to receive MIPI inputs, whereas the external display 1833 is configured to receive DVI or HDMI inputs, and all video sources generate DVI or HDMI outputs, the HMD may comprise an embedded digital signal processor (DSP) having system-on-a-chip (SOC) 1811, as shown, configured to process DVI and HDMI streams from the HMD video source 1801 and output video in MIPI, DVI and HDMI streams. The SOC 1811 may reduce the burdens on other processor elements by combining the various input and output video streams required for displaying the AR rendered physical environment to the at least one user. Integration of the streaming algorithms within an embedded DSP may provide relatively low power processing.

The SOC 1811 provides the MIPI stream to a 2-to-1 video selector 1825. The DSP further comprises a 1-to-2 video splitter 1821 for providing two HDMI or DVI streams to each of: (i) an integrated circuit (IC) 1813, which converts the HDMI output of the external video source 1803 into a MIPI stream; and (ii) a first 2-to-1 video select 1823 to provide a combined DVI HDMI signal to the external device 1803 from the SOC 1811 and the IC 1813. A second 2-to-1 video select 1825 combines the converted (i.e., from DVI or HDMI to MIPI) HMD video stream with the MIPI stream from the (IC) 1813 to generate the stream to be displayed by the HMD display system 1831.

As shown in FIG. 16, the HMD may comprise a display system having a display screen 1607 and two magnification lenses 1605 or lens arrays. The distance d₁₆ between the display screen 1607 and the magnification lenses 1605 is preferably selectively adjustable for user-customisable focussing, and the IPD distance between the two lenses 1605 may be further configurable to accommodate different IPDs for different users, as previously described. The lenses 1605 or lens arrays may be interchangeable with other lenses or lens arrays, as the case may be, depending on the desired application. The display system may be further operable to display content in 3D if, for example, the screen 1607 is equipped with a parallax barrier (in which case, the user would not need to wear 3D glasses), or the screen is a shutter-based or polariser-based 3D display (in which case, the display system would either require an intermediary lens array between the screen and the user or that the user wear 3D glasses). The screen 1607 may have a touch panel input. The screen 1607, the processor 1601, and/or the imaging system may form a single unit or module that can be, for example, removably slid into the HMD for simple replacement, upgrading or reconfiguration. For example, the unit may be embodied by a tablet operable to capture, render, combine and/or display the AR rendered physical environment to the user equipped with an HMD, whether with or without input from, and output to, other systems and/or components described herein. Alternatively, the components of the display system may be embedded in the HMD, with processing and imaging occurring in discrete subsystems and/or components.

In addition to visual inputs and outputs previously described in greater detail, user engagement with a physical environment may be enhanced by other types of input and output devices providing, for example, haptic or audio feedback, as well as through peripherals, such as, for example, emitters, receivers, vests and other wearables. The processor may therefore be operable to communicate with a plurality of devices providing other types of interaction with the physical environment, such as the devices described herein.

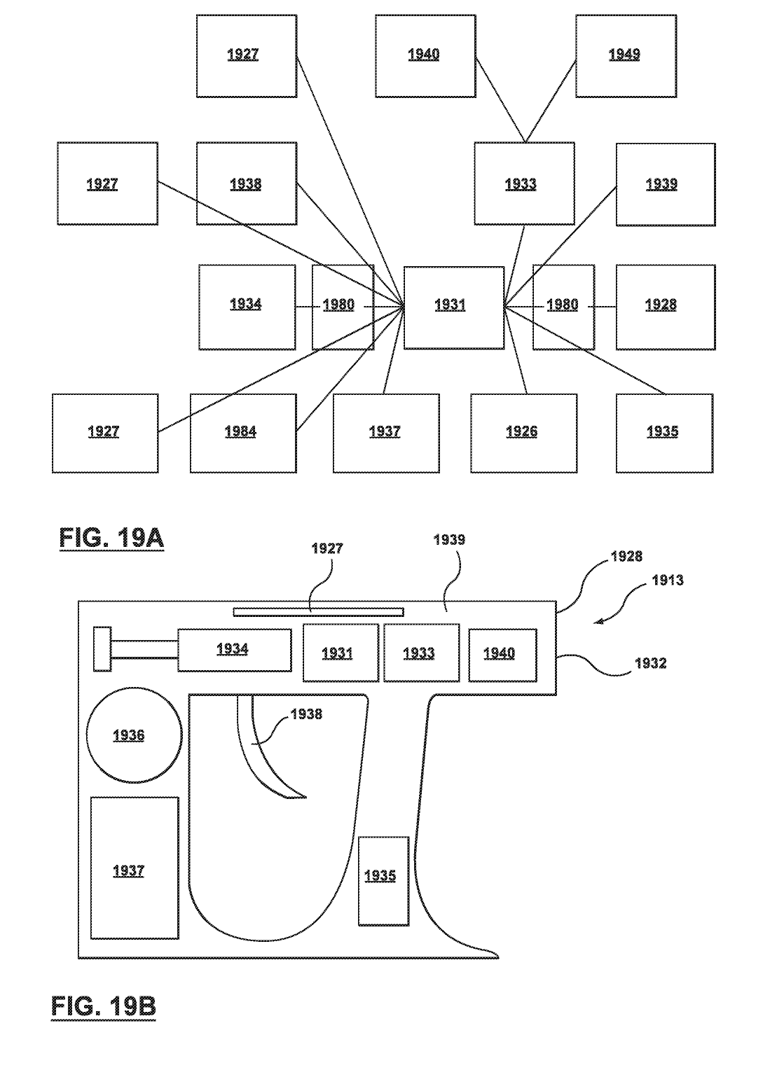

As shown in FIGS. 19A and 19B, players may be equipped with emitter/receiver devices embodied, for example, as a combination of a vest and a gun, where the gun is an emitter device and the vest is a receiver device. As shown in FIG. 19A, and schematically in greater detail in FIG. 19B, the emitter 1913 may be shaped as a gun and configured to emit an IR beam 1932 into a physical environment. The emitter 1913 may comprise: a microprocessor 1931 to perform any necessary processing onboard the emitter; an IR LED driver 1933 in communication with the microprocessor 1931 for driving an IR LED source 1940 to emit the IR beam 1932 into the physical environment; a power management system 1935 with a battery, or other suitable power source, to power the microprocessor 1931 and other components; an LPS and inertial measurement unit comprising, for example, a 3D gyroscope, accelerometer and/or compass sensor 1927, and/or an ultrasonic, RF or other wireless positioning device for providing a location, orientation, velocity, and/or acceleration of the emitter 1913 to the microprocessor 1931; a wired or wireless communication interface 1926 for mediating communications between the microprocessor 1931 and other components of the AR system in the physical environment; and a trigger switch 1938 in communication with the microprocessor 1931 for receiving user input and initiating the IR LED driver 1933 to cause the IR LED source to emit the IR beam into the physical environment. The emitter 1913 may further comprise trigger LED sources 1938 in communication with the microprocessor 1931 to provide a visual indication that the user has depressed the trigger switch 1938; recoil feedback 1934 in communication with the microprocessor to simulate recoil from emitting an IR beam; haptic feedback unit 1936 for providing haptic feedback to the user based on signals from the microprocessor 1931; biometric sensing 1937 to obtain biometric data, such as, for example, heart rate, breathing rate or other biometric data from the user, and transmit the biometric data to the microprocessor 1931 for optional sharing with other components or systems in the physical environment; and a display surface, such as an LCD screen 1939, to display information about the emitter 1913.

The various LPSs 1927 or 128 in the emitter 1913 may function in the same manner as the LPSs previously described with reference to the HMD. When the user engages the trigger through the trigger switch 1938, which may be, for example, a push button or strain gauge, the microprocessor 1931 registers the user input and causes the IR LED driver 1933 to cause the IR LED 1940 source to emit a laser beam into the physical environment; however, the emitter 193 may further enhance user perception if, for example, the microprocessor initiates a solenoid providing recoil feedback 1934 to the user. The haptic feedback unit may consist of a vibrator mounted to the emitter 1913 which may be activated whenever the user attempts to initiate firing of the beam.

Biometric sensors 1937 in the emitter 1913 are configured to gather biometric information from the user and provide that information to, for example, the user's HMD. In an exemplary scenario, an increase in the user's heart rate during a laser tag game, the microprocessor may escalate haptic feedback to further excite the user, thereby adding a challenge which the user must overcome in order to progress.

When the trigger switch is depressed, the microprocessor may cause LEDs 1938 to be displayed on the emitter as a visual indication of emission of the beam. The user's HMD, which corresponds with the emitter 1913, may similarly display a visual indication of the emission in the colour wheel of the HMD's display system, as previously described.

Preferably, the IR LED source 1940 is paired with optics 1940 to collimate the IR beam. The IR LED driver 1933 modulates the beam according to user feedback and game parameters obtained from the microprocessor 1931. The LCD screen 1939 may display information, such as ammo or gun type on the surface of the emitter 1913.

Any peripheral, including the emitter and the receiver, may comprise an inertial measurement system, such as, for example, an accelerometer, an altimeter, a compass, and/or a gyroscope, providing up to 9 DOF, to determine the orientation, rotation, acceleration, speed and/or altitude of the peripheral. The various LPS and inertial measurement system components 1927 may provide information about the orientation and location of the emitter 1913 at the time the beam is emitted. This information, which is obtained by the microprocessor 1931 and transmitted to the user's HMD, other users' HMDs, the server or the console via the wireless communication interface 1926, can be used during AR rendering of the physical environment, by for example, rendering the predicted projection of IR beam as a coloured path or otherwise perceptible shot.

With reference to FIG. 3, it is apparent that the emitter 13 may be understood as a slave accessory to the master HMD 12. The emitter 13 of a first user is configured to function in conjunction with the receiver 14 of a second user. In use, the emitter 13 emits a beam, such as an IR beam, into the physical environment, where it may encounter the receiver 14, as shown by the stippled line, and as previously described.

Preferably, each emitter 13 in the system 10 shown in FIG. 3 emits a beam having a unique and identifiable frequency. The receiver 14, upon detecting the beam, may determine the frequency of the beam and compare that frequency with the known frequencies for the emitters in the system. The known frequencies may be associated to the emitters 13 for the system 10 in a database on the server 300 or console 11, or amongst the HMDs 12. The reception in the receiver 14 of the beam from a given emitter 13 may therefore be identified as emanating from the specific emitter 13, in order to record the “hit” as an incident in the parameters for a game, for example.

Further, the processor may assess game parameters, such as, for example, damage suffered by a user after being hit by another user. The processor may record a hit as a point to the user whose emitter emitted a beam received in another user's receiver, and as a demerit to the other user who suffered the harm. Further, the other user's HMD 12 or receiver 14 may initiate one or more haptic, audio or visual feedback systems to indicate to that other user that he has been hit.

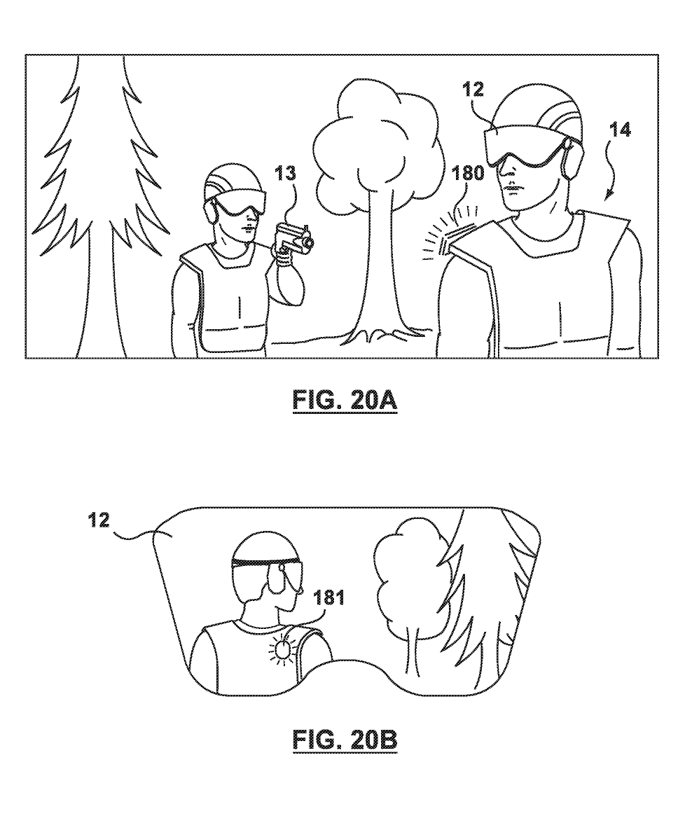

Referring now to FIG. 20A, an exemplary receiver 14 is shown. The receiver 14 may take form as a vest worn by its user. The receiver 14 comprises at least one sensor operable to sense beams emitted by corresponding emitter 13. If, for example, the emitter 13 emits an IR beam, the corresponding receiver 14 is operable to detect the IR beam.

The receiver 14 may further provide visual, haptic and other sensory outputs to its user, as well as other users in the physical environment.

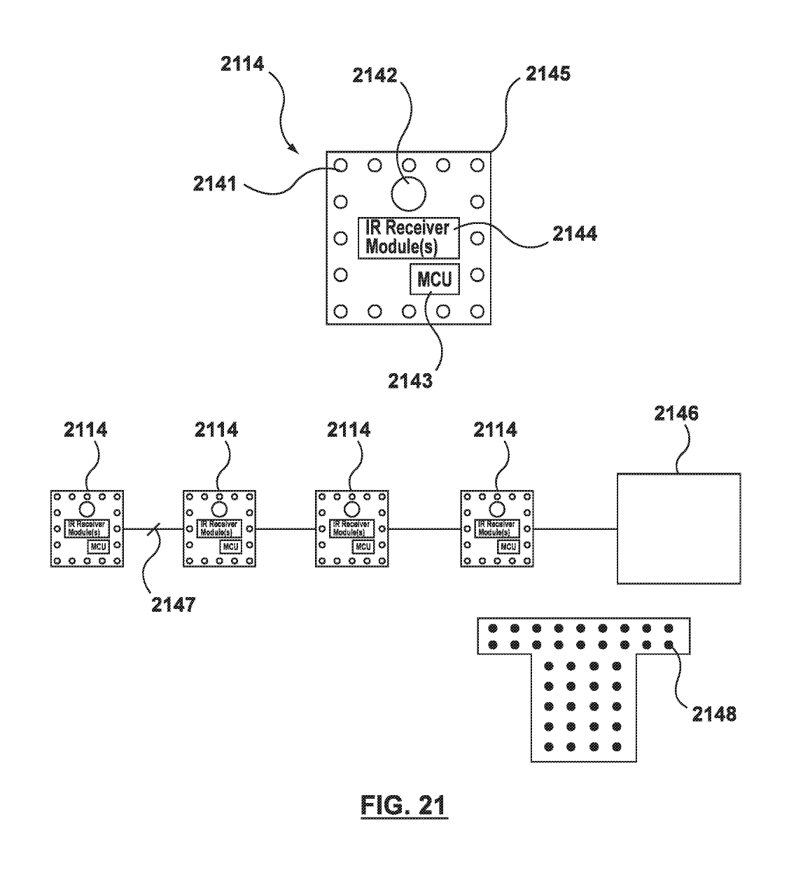

An exemplary receiver layout is shown in FIG. 21. The receiver 2114 may comprise: IR LEDs 2141 to provide visual indications that the receiver's user had been hit; a vibrator 2142 to provide haptic feedback to the user; a microprocessor 2143 in communication with the other components of the receiver 2114 for local receiver management and communication with adjacent receivers in a series; an IR sensor 2144 to detect and report beams to the microcontroller 2143. Multiple receivers 2114 may be placed in parallel to form a series of n receivers 2114. The series of receivers may further comprise a main master receiver module 2146, which is responsible for communication between, and master control of, the individual receivers 2114. Alternatively, one of the receivers 2114 may be a master to the other receivers 2114 in the series. The receivers 2114, which may be formed as a series of the aforementioned components embedded on a flexible material 2145, such as, for example, PCBA, may be tailored into wearable technology to be worn by the user, such as the vest shown in FIG. 20A.

Referring again to FIGS. 20A and 20B, upon sensing a beam emitted by an emitter 14, the at least one sensor on the receiver 14 determines the frequency of the signal and notifies the microcontroller of the reception and frequency of the beam. The microprocessor may communicate that information to the main master receiver module, or directly to the user's HMD 12, or to other system processors, such as, for example, the console 11 or server 300, as shown in FIG. 1, one or both of which register the event and determines, based at least on the frequency of the beam, which emitter 14, emitted the beam.

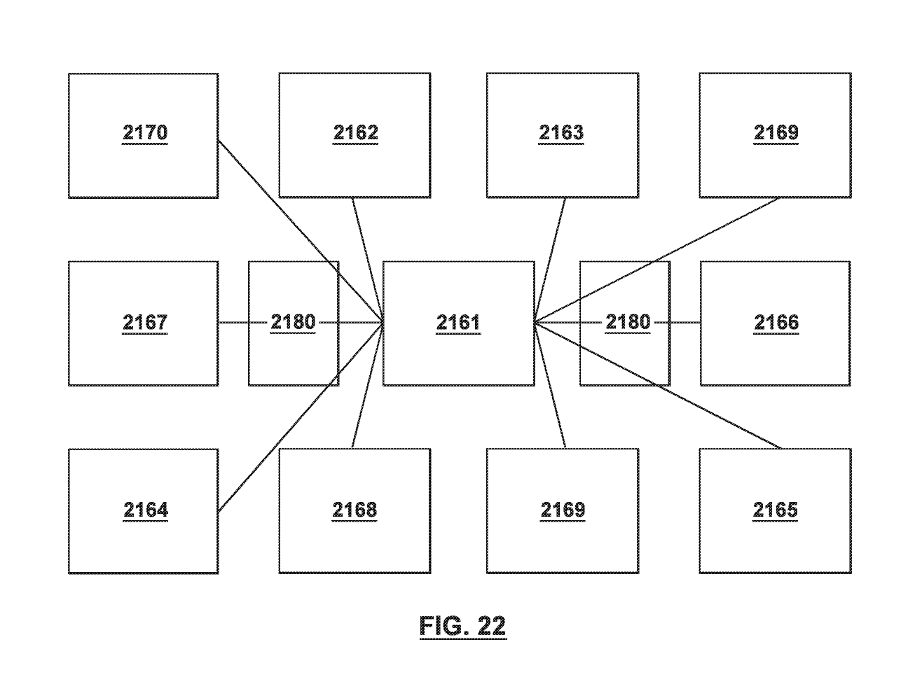

Registration of a “hit”, i.e., reception of a beam, may trigger various feedback processes described herein. For example, the user's vest may comprise haptic output to indicate to the user that he has suffered a hit. Further, as described, the user's receiver 14 may comprise at least one LED 180 which the microprocessor activates in response to a hit. Similar to the emitter 13, the receiver 14 may comprise biometric sensors, such as the biometric sensors 2168 shown in FIG. 21, to detect user parameters. The receiver 2114 further comprises a battery management system 2165, as shown in FIG. 22.

With reference now to FIG. 22, an exemplary system architecture for the receiver is shown. The receiver may consist of one or more receiver modules as well as other peripherals. The components of the receiver modules are directly connected to a microprocessor 2161. The receiver module may comprise LEDs 2162 to provide visual indications of a hit, at least one IR sensor 2163, haptic feedback 2164, and support electronics 2180 providing ancillary electronics suitable for the components of the receiver. When the at least one IR sensor 2163 senses modulated IR light, the microprocessor 2161 causes the LEDs 2162 to emit light. Another user whose HMD captures the light emitted by the LEDs 2162 may render incorporate the emitted light to render CGI graphics to overlay over the light. For example, as illustrated in FIGS. 20A and 20B, the processor of the other user's HMD may overlay blood 2081 or other effects indicating a hit over the receiver 14 when the receiver's LEDs 2080 are engaged.

Referring again to FIG. 22, the user's receiver may communicate with her HMD or other components in the physical environment via a wired or wireless communications interface 2169. The receiver may further comprise at least one LPS system, as previously described with respect to the HMDs and emitters. Further, as with the emitter, the receiver may comprise a recoil feedback system, comprising, for example a servo, to simulate recoil. For example, in a game of augmented reality tennis, the receiver may be configured as a tennis racket. When hitting a “ball”, the microprocessor 2161 may initiate the recoil feedback to simulate the hit. In the same exemplary scenario, the receiver may also act as an emitter. For example, the tennis racket may act as a receiver when receiving the “ball”, but then as an emitter when serving the “ball”. A user may selectively engage or disengage receiving and emitting functionality by, for example, engaging a trigger switch 2170.

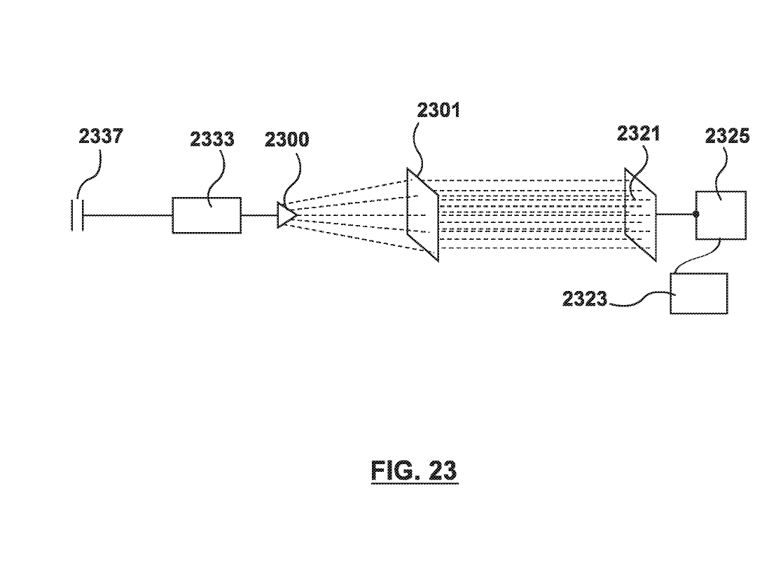

The beam emitted from an emitter to a receiver may be collimated. As shown in FIG. 23, a first user's emitter comprises an IR LED 2300 which emits an IR beam towards the physical environment. The IR beam is collimated by an optical lens 2301 prior to emission into the physical environment. The emitter further comprises an oscillator 2337 connected to an LED driver 2333 to modulate the frequency of the IR beam. The IR beam travels through the physical environment until it encounters an IR receiver 2321 of a second user. The receiver comprises a sensor connected to a demodulator 2325 to determine and remove the frequency of the beam. The sensor informs the receiver's microprocessor 2323 of the “hit” to initiate further course of action, as previously described. The microprocessor 2323 may use the frequency of the beam to identify the source of the beam, and may even modify subsequent events based on, for example, the type of “gun”, user, “ammunition” or other parameter responsible for the “hit”. Alternatively, the game play parameters of a game may dictate that only certain users may “hit” certain other users. In the latter scenario, the microprocessor may only register a “hit” if the beam has a frequency corresponding to a user permitted to hit the recipient equipped with the receiver 2321. By collimating and modulating emitted beams with specific frequencies, noise, including solar noise and noise from multiple IR sources, may be mitigated. This may provide advantages in applications where, for example, multiple users are equipped with IR emitting peripherals.

The emitter initiates data transfer to the receiver via a modulated frequency signal. The data is transferred to the receiver and is processed for key game parameters such as type of gun hit, type of blast, type of impact, the user ID, and other parameters using IR communication. This allows for a more accurate reaction between multiple emitters of varying types to be processed as different type of effects. For example, if an in-game virtual IR explosion was to occur, the data transferred to the receiver will trigger an explosion-based reaction on the receiver(s) which in turn will produce a specified desired effect on the HMD(s). The HMD(s) will create imagery specific to the desired effect based on the receiver(s) IR light frequency and use this information to overlay the required visual effect.

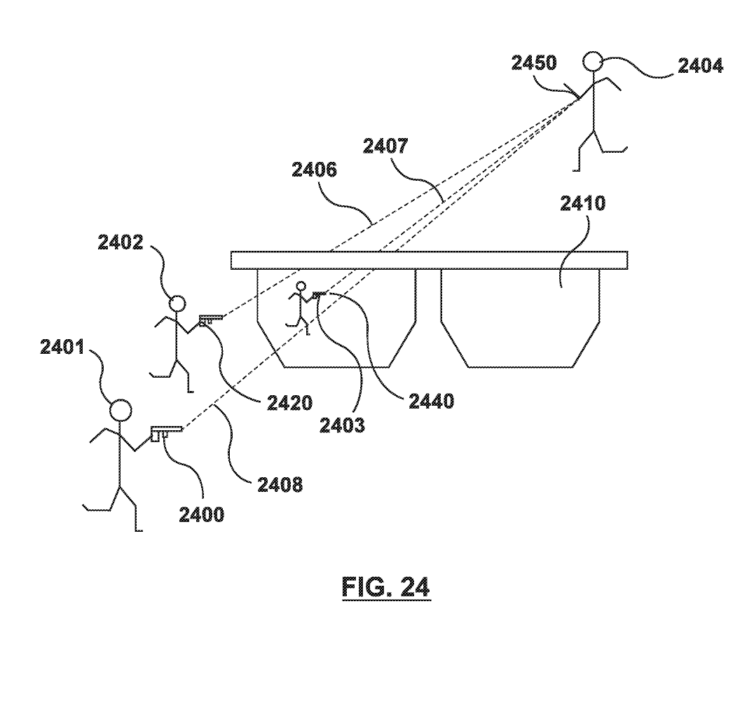

Referring now to FIG. 24, an exemplary scenario is shown in which multiple users 2401, 2402, 2403, and 2404, each being equipped with an emitter, 2400, 2420, 2440 and 2450, respectively, occupy a physical environment. Another user, equipped with an HMD occupies and observes on his display system 2410 the same physical environment as the other users. As previously described, AR rendering of the physical environment displayed by the user's display system 2410 may comprise rendering of any users and their related interactions within the field of view of the AR rendered physical environment visible on the display system 2410. For example, user 2403, emission beams 2408, 2406 and 2407 may fall within the field of view of the observing user at a given time. The world space coordinates and trajectories for elements within the field of view may be obtained by some or all components, users and systems in the physical environment through previously described positioning techniques.

In the exemplary scenario, for example, the local position of user 2403 may be determined by that user's HMD (not shown) according to, for example, trilateration, or as otherwise described herein. Further, the location and orientation of user 2403's emitter 2440 when emitting beam 2407 may be determined from the LPS and inertial measurement system of the emitter 2440. All position and orientation data for the user 2403 and her emitter 2440 may be shared with the processor of the HMD worn by the observing user, and the processor may enhance those elements for display to the display system 2410 of the observing user. The beam 2407, for example, may be rendered as an image of a bullet having the same trajectory as the beam 2407. Further, the user 2403 may be rendered as a fantastical character according to parameters for the game.

Additionally, a user's peripherals, such as a receiver 14 or HMD 12 may comprise an IR LED array 180, as previously described, and as shown in FIG. 20A. FIGS. 20A and 20B illustrate an exemplary scenario. The IR LEDs 180 may activate upon the occurrence of one or more events, such as when the user is “hit” by another user's emitter 13. The user who has been hit may appear within the field of view of another user, i.e., an observer, equipped with an HMD 12, as shown in FIG. 20B. If the observer's HMD 12's imaging system is equipped to detect tags, such as through an IR camera, the observer's HMD 12 may render the visible LED array 180 accordingly, so that the observer perceives the array 180 on the vest 14 of the user who has been hit as a wound 181.

In embodiments, each user's HMD may be equipped with at least one receiver to, for example, detect a head shot. Similarly, the HMD may further comprise biometric sensors, as previously described with respect to the emitters and receivers for providing similar enhancements. The HMD may further comprise audio and haptic feedback, as shown, for example in FIG. 7. Haptic feedback may be provided by one or more vibrators mounted on the HMD, or the HMD may comprise deep-bass speakers to simulate vibrations.

While interactions between emitters and receivers have been described herein primarily as half-duplex communications, obvious modifications, such as equipping each emitter with a receiver, and vice versa, may be made to achieve full duplex communication between peripherals.

Additional peripherals in communication with the HMD may further comprise configuration switches, such as, for example push buttons or touch sensors, configured to receive user inputs for navigation through menus visible in the display system of the HMD and communicate the user inputs to the processor.

It will be appreciated that the systems and methods described herein may enhance or enable various application. For example, by using sports-specific or configured peripherals, AR sports training and play may be enabled. In a game of tennis, exemplary peripherals might include electronic tennis rackets. In a soccer game, users may be equipped with location and inertial sensors on their feet to simulate play.

Further exemplary applications may comprise role-playing games (RPGs), AR and VR walkthroughs of conceptual architectural designs applied to physical or virtual spaces, and for defence-related training.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

What is claimed is:

1. A local positioning system for determining a position of a user interacting with an augmented reality of a physical environment on a wearable display, the system comprising:
a) at least one emitter, located at a known location in the physical environment, to emit a signal;
b) a receiver disposed upon the user to detect each signal; and
c) a processor to:
i) determine, from the at least one signal, the displacement of the receiver relative to the at least one emitter;
ii) and, combine the displacement with the known location.

2. The system of claim 1, wherein:
a) the at least one emitter is either one of a 2-dimensional magnetic emitter generating two orthogonal magnetic fields or a 3-dimensional magnetic emitter generating three orthogonal magnetic fields, and the signal is provided by the magnetic fields; and
b) the receiver is a 2-dimensional or 3-dimensional magnetic sensor configured to detect the magnetic fields.

3. The system of claim 1, wherein the system comprises at least three emitters and the processor determines the displacement by determining the distance travelled by each signal between each emitter and the receiver, and trilaterating for at least three of the distances.

4. The system of claim 3, wherein the signal is any one of a laser, infrared, radio or ultrasonic signal.

5. The system of claim 4, wherein each signal comprises identification information for its emitter.

6. The system of claim 5, wherein the identification information comprises a modulated frequency for the signal.

7. A method for determining a position of a user interacting with an augmented reality of a physical environment on device wearable display, the method comprising:
a) by a receiver disposed upon the user, detecting each signal from each of at least one receiver with a corresponding known location within the physical environment;
b) in a processor, determining, from the at least one signal, the displacement of the receiver relative to the at least one emitter, and combining the displacement with the known location for at least one emitter.

8. The method of claim 7, wherein detecting each signal comprises detecting at least two magnetic fields.

9. The method of claim 7, comprising detecting each signal from each of at least three emitters, and determining the displacement by calculating the distance travelled by each signal between the emitter and the receiver, and trilaterating for at least three of the distances.

10. The method of claim 3, wherein the signal is any one of a laser, infrared, radio or ultrasonic signal.

11. The method of claim 4, wherein each signal comprises identification information for its emitter.

12. The method of claim 5, wherein the identification information comprises a modulated frequency for the signal.
